(19) United States
(12) Patent Application Publication
(10) Pub. No.: US 2019/0092644 A1
(43) Pub. Date: Mar. 28, 2019

(54) INORGANIC POROUS FRAMEWORKLAYERED DOUBLE HYDROXIDE CORESHELL MATERIALS

(71) Applicant: SCG CHEMICALS CO., LTD., Bangkok, (TH)

(72) Inventors: Dermot O'Hare, Oxford (GB); Jean-Charles Buffet, Oxford (GB); Chunping Chen, Oxford (GB)

(21) Appl. No.: 15/745,375

(22) PCT Filed: Jul. 15, 2016
(86) PCT No.: PCT/GB2016/052158

§ 371 Date: Jan. 16, 2018

(30) Foreign Application Priority Data
Jul. 16, 2015 (GB) 1512458.9

(51) Int. Cl. C01B 39/02; C01B 39/54; C01B 39/20; C01B 39/26; C01B 39/14; C01B 39/46; C01B 37/02; C01F 7/00

(52) U.S. Cl. CPC C01B 39/026; C01B 39/54; C01B 39/20; C01B 39/26; C01B 39/14; C01B 39/46; B82Y 30/00; C01F 7/004; C01P 2006/17; C01P 2002/88; C01P 2004/04; C01P 2002/01; C01P 2002/72; C01B 37/02

(57) ABSTRACT

Core @ layered double hydroxide shell materials of the invention have the formula:

Tₚ@{[M^{z+}₍₁₋ₓ₎M′ₓ^{y+}(OH)₂]^{a+}(Xⁿ⁻)_{a/n}·bH₂O·c(AMO-solvent)}_{q}

wherein T is a solid, porous, inorganic oxide-containing framework material, M^{z+} is a metal cation of charge z or a mixture of two or more metal cations each independently having the charge z; M′^{y+} is a metal cation of charge y or a mixture of two or more metal cations each independently having the charge y; z=1 or 2; y=3 or 4; 0<x<0.9; b is 0 to 10; c is 0.01 to 10; p>0; q>0; Xⁿ⁻ is an anion; with n>0; a=z(1−x)+xy−2; and AMO-solvent is an organic solvent which is completely miscible with water.

Also disclosed are the products obtained by calcining the core @ layered double hydroxide shell materials which calcination products are core @ mixed metal oxide materials having the formula

Tₚ@[{M^{z+}₁₋ₓM′^{y+}ₓO_{w}]ₚŸ]

wherein T is a solid, porous, inorganic oxide-containing framework material, M^{z+}₁₋ₓM′^{y+}ₓO_{w} is a mixed metal oxide, or mixture of mixed metal oxides, which may be crystalline or non-crystalline, wherein M^{z+} and M′^{y+} are different charged metal cations; M^{z+} is a metal cation of charge z or a mixture of two or more metal cations each independently having the charge z; M′^{y+} is a metal cation of charge y or a mixture of two or more metal cations each independently having the charge y; z is 1 or 2; y is 3 or 4; 0<x<0.9; w>0; p>0 and q>0; Ÿ is the residue of an Xⁿ⁻ anion in which n>0.

### BACKGROUND

Layered double hydroxides (LDHs) are a class of compounds which comprise two or more metal cations and have a layered structure. A review of LDHs is provided in Structure and Bonding; Vol. 119, 2005 Layered Double Hydroxides ed. X Duan and D. G. Evans. The hydrotalcites, perhaps the most well-known examples of LDHs, have been studied for many years. LDHs can intercalate anions between the layers of the structure.

Core shell particles are described in the literature by “core @ shell” (for example by Teng et al, Nano Letters, 2003, 3, 261-264), or by “core/shell” (for example J. Am. Chem. Soc., 2001, 123, pages 7961-7962). We have adopted the “core @ shell” nomenclature as it is emerging as the more commonly accepted abbreviation.

SiO₂/LDH core-shell microspheres are described by Shao et al, Chem. Mater. 2012, 24, pages 1192-1197. Prior to treatment with a metal precursor solution, the SiO₂ microspheres are primed by dispersing them in an Al(OOH) primer sol for two hours with vigorous agitation followed by centrifuging, washing with ethanol and drying in air for 30 minutes. This priming treatment of the SiO₂ microspheres was repeated 10 times before the SiO₂ spheres thus coated with a thin Al(OOOH) film were autoclaved at 100° C. for 48 hours in a solution of Ni(NO₃)₂·6H₂O and urea. Hollow SiO₂—NiAl-LDH microspheres obtained by this process were reported as exhibiting excellent pseudocapacitance performance. Unfortunately, the requirement for the Al(OOOH) priming of the SiO₂ surface, prior to LDH growth, makes this process unsuitable for use on an industrial scale.

Chen et al, J. Mater. Chem. A, 1, 3877-3880 describes the synthesis of SiO₂ @ MgAl-LDHs having use in the removal of pharmaceutical pollutants from water. The synthesis described comprises coprecipitating LDH from a metal precursor solution containing the SiO₂ microspheres followed by ultrasound assisted direct growth of LDH nanosheets on the surface of the SiO₂ microspheres. Unfortunately, the reported method does not allow the morphology of the surface LDHs to be tuned and the surface area of the product SiO₂ @ LDHs is not high.

Molecular sieves are materials typically having very small pores of precise and uniform size. According to IUPAC notation, microporous materials have pore diameters of less than 2 nm (20 Å) and macroporous materials have pore diameters of greater than 50 nm (500 Å). Mesoporous materials, which exist between the microporous and macroporous materials, have pore diameters in the range 2 to 50 nm (20-500 Å). Molecular sieves are typically composed of a porous framework structure which contains ring structures composed in particular of atoms in a tetrahedral arrangement. One representative of such framework structures composed of atoms in a tetrahedral arrangement is the group of the zeolites, in which such ring structures are formed. Medium pore size is understood as meaning that, in a molecular sieve having a framework structure that forms a ring structure, the ring is formed of at least ten atoms. Large pore size is understood as meaning ring structures formed of at least twelve atoms.

Generally when an inorganic, porous, framework, such as a zeolite or molecular sieve, is coated (or surface treated) with a precursor or a material such as LDH, the inherent porosity and surface area of the inorganic, porous, framework material is reduced. This typically arises due to the coating ‘filling in’ or covering the pores of the inorganic framework.

It is therefore an object of the present invention to provide inorganic porous framework @ LDH core-shell materials, wherein the thickness, size and morphology of the LDH layer grown on the surface of the inorganic porous framework material can be tuned easily for different applications. Furthermore, it is an objective of the present invention to provide inorganic porous frameworks coated with LDHs with porosities comparable to those of their constituent materials. It is also a further object of the present invention to provide inorganic porous framework @ LDH core-shell materials that have a high surface area.

### SUMMARY OF THE INVENTION

According to a first aspect of the present invention, there is provided a core @ layered double hydroxide shell material having the formula:

Tₚ@{[M^{z+}₍₁₋ₓ₎M′ₓ^{y+}(OH)₂]^{a+}(Xⁿ⁻)_{a/n}·bH₂O·c(AMO-solvent)}_{q}

wherein T is a solid, porous, inorganic oxide-containing framework material; M^{z+} is a metal cation of charge z or a mixture of two or more metal cations each independently having the charge z; M′^{y+} is a metal cation of charge y or a mixture of two or more metal cations each independently having the charge y;
z=1 or 2;
y=3 or 4;
0<x<0.9;
b is 0 to 10;
c is 0.01 to 10;
p>0;
q>0;
X^{II-} is an anion; with n>0;
a=z(1−x)+xy−2; and
AMO-solvent is an organic solvent which is completely (i.e. ideally 100%) miscible with water.

According to a second aspect of the present invention, there is provided a method of making a core @ layered double hydroxide shell material, as defined herein, which method comprises the steps;
(a) contacting a metal ion-containing solution containing metal ions M^{z+} and M′^{y+} and particles of the framework material in the presence of a base and an anion solution; and
(b) optionally treating the product with AMO-solvent and recovering the solvent treated material to obtain the core @ layered double hydroxide material.

According to a third aspect of the present invention, there is provided a core @ layered double hydroxide shell material obtainable by, obtained by or directly obtained by the process described here.

According to a fourth aspect of the present invention, there is provided a core @ mixed metal oxide material having the formula:

Tₚ@{[M^{z+}₁₋ₓM′^{y+}ₓO_{w}]ₚŸ]

wherein T is a solid, porous, inorganic oxide-containing framework material, M^{z+}₁₋ₓ M′^{y+}ₓO_{w} is a mixed metal oxide, or mixture of mixed metal oxides, which may be crystalline or non-crystalline, wherein M^{z+} and M′^{y+} are different charged metal cations; M^{z+} is a metal cation of charge z or a mixture of two or more metal cations each independently having the charge z; M′^{y+} is a metal cation of charge y or a mixture of two or more metal cations each independently having the charge y; z is 1 or 2; y is 3 or 4; 0<x<0.9; w>0; p>0 and q>0; Ÿ is the residue of an Xⁿ⁻ anion in which n>0.

According to a fifth aspect of the present invention, there is provided a method of making a core @ mixed metal oxide material, as defined herein, comprising subjecting a core @ layered double hydroxide shell material, as defined herein, to heat treatment.

### DETAILED DESCRIPTION OF THE INVENTION

### Definitions

The following terms “core @ layered double hydroxide shell”, “inorganic porous framework @ LDH core-shell material” and “core @ LDH” are be used synonymously throughout the application. All of these terms may be used interchangeably to refer to a central core material (e.g. an inorganic porous framework material) which is coated with a layer of layered double hydroxide. Similarly, the term “Tp @ {[M^{z+(}₁₋ₓ)M′ₓ^{y+}(OH)₂]^{a+}(Xⁿ⁻)_{a/n}·bH₂O·c(AMO-solvent)}_{q}” will be understood as referring to a solid, porous, inorganic oxide-containing framework material that is coated with one or more layers of layered double hydroxide of the given formula.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

### Inorganic Porous Framework @ LDH Core-Shell Materials of the Present Invention

The present invention provides a core @ layered double hydroxide shell material, as defined herein. The core @ layered double hydroxide shell materials are prepared by growing a LDH on to the surface of the solid, porous, inorganic oxide-containing framework material.

By growing the LDHs on the surface of the solid, porous, inorganic oxide-containing framework material the inventors surprising found that discrete particles of core @ layered double hydroxide material with high porosities, surface area and excellent absorption properties could be achieved. The treatment with and subsequent inclusion of an aqueous miscible organic (AMO) solvent in the core @ layered double hydroxide shell material was found to further increase the improvement in porosity, surface area and absorption demonstrated by the core @ layered double hydroxide shell materials.

Furthermore, by growing the LDHs on the surface of the solid, porous, inorganic oxide-containing framework material the thickness of the LDH layer is able to be controlled, which advantageously allows for uniform particles to be prepared.

Suitably, the core @ layered double hydroxide materials of the present invention comprise an LDH layer with an average thickness of between 5 nm and 300 nm. More suitably, the core @ layered double hydroxide materials of the present invention comprise an LDH layer with an average thickness of between 30 nm and 200 nm. Yet more suitably, the core @ layered double hydroxide materials of the present invention comprise an LDH layer with an average thickness of between 40 nm and 150 nm. Most suitably, the core @ layered double hydroxide materials of the present invention comprise an LDH layer with an average thickness of between 40 nm and 100 nm.

Furthermore, the core @ layered double hydroxide materials of the present invention allow for coated solid, porous, inorganic oxide-containing framework materials which retain the surface area and porosity characteristics of their component materials.

In a particular embodiment, the core @ layered double hydroxide materials have specific surface area (a Brunauer-Emmett Teller (BET) surface area) of at least 50 m²/g, preferably at least 100 m²/g, more preferably at least 250 m²/g, yet more preferably at least 350 m²/g, even more preferably at least 450 m²/g, still more preferably at least 550 m²/g, and most preferably at least 650 m²/g.

In another embodiment, the core @ layered double hydroxide materials have an external surface area of at least 50 m²/g, preferably at least 100 m²/g, more preferably at least 125 m²/g, even more preferably at least 150 m²/g, and most preferably at least 175 m²/g.

In a further embodiment, the core @ layered double hydroxide materials have a micropore surface area of at least 50 m²/g, preferably at least 100 m²/g, more preferably at least 150 m²/g, yet more preferably at least 200 m²/g, even more preferably at least 300 m²/g, and most preferably at least 400 m²/g.

### Inorganic Porous Framework

A core-layered double hydroxide composite material according to the present invention comprises a solid core particle having solid LDH attached to its surface.

The core material, as stated above, is a solid, porous, inorganic oxide-containing framework material. Typically, this framework material is a molecular sieve which is composed of a porous framework structure which contains ring structures comprising atoms in a tetrahedral arrangement. The framework, as stated above, is porous and comprises pores having a diameter of up to 50 nm, suitably up to 40 nm, more suitably up to 30 nm and most suitably up to 20 nm. Accordingly, the framework material may be either microporous, containing pores with a diameter less than 2 nm, or mesoporous, containing pores with a diameter of between 2 and 50 nm.

In one embodiment, the framework material is microporous, i.e. having pores of diameter less than 2 nm, suitably less than 1.5 nm and more suitably less than 1 nm.

In another embodiment, the framework material is mesoporous, i.e. having pores of diameter of between 2 nm to 50 nm, suitably between 2 nm and 30 nm, more suitably between 2 nm and 20 nm and most suitably between 2 nm and 10 nm.

Preferably, the molecular sieve comprises, preferably is selected from, a silicate, for example aluminium silicate, vanadium silicate or iron silicate. Alternatively, the molecular sieve comprises or is silicon-aluminium phosphate (SAPO) or aluminium phosphate (AIPO).

According to an embodiment of the invention, the molecular sieve material is aluminium silicate. Typically, the silicon: aluminium molar ratio is from 1 to 100. Preferably, the aluminium silicate is one in which the silicon: aluminium ratio is 1 to 60, preferably 1 to 50, more preferably 1 to 40 and most preferably 1 to 30.

According to an embodiment, the solid, porous, inorganic oxide-containing framework material is a zeolite material. Zeolites are microporous crystalline solids with well-defined structures and, generally, they contain silicon, aluminium and oxygen in their framework and cations, water and/or other molecules within their pores. Typically, the zeolite material will be composed of aluminium silicate. Preferably, the aluminium silicate zeolite has a framework structure selected from zeolite types LTA, FAU, BEA, MOR and MFI. In the case of the latter (BEA, MOR and MFI), this is the framework code according to the Structure Commission of the International Zeolite Association. Such three letter codes are assigned to particular zeolite structures to identify the type of material they are composed of and the structure they adopt. For example, LTA is the code for zeolite type Linde Type A and MFI is the code for zeolite type ZSM-5.

The aluminium silicate zeolite may have a framework structure containing non-framework cations. Such cations may be organic cations or inorganic cations. A framework structure may contain both inorganic and organic cations as non-framework cations. Such non-framework cations may, for example, be selected from NR₄⁺, where R is an optionally-substituted alkyl group (e.g. R=Me, Et, Pr, Bu) Na⁺, K⁺, Cs⁺ or H⁺. Suitably, the non-framework cation is selected from Na⁺, H⁺ or NR₄⁺, wherein R is methyl or ethyl.

The aluminium silicate zeolite may be a crystalline aluminosilicate zeolite having a composition, in terms of mole ratios of oxides, as follows:

αMⁿ⁺_{2/n}O:Al₂O₃:βSiO₂:γH₂0

wherein Mⁿ⁺ is at least one cation having a valence n, α=0.9±0.2; β is at least 2 and γ is between 0 and 40.

Each zeolite classification type (e.g. LTA, FAU etc) may have one or more further sub divisions associated with it. For example, FAU zeolites can be further sub divided into X or Y zeolites depending on the silica-to-alumina ratio of their framework; with X zeolites having a silica-to-alumina ratio of between 2 to 3 and Y zeolites having a silica-to-alumina ratio of greater than 3. It will be understood that all such sub-divisions are covered by the definitions recited above.

In a particular embodiment of the present invention, the solid, porous, inorganic oxide-containing framework material is selected from: i) an aluminium silicate with a framework structure selected from zeolite types LTA, FAU, BEA, MOR or MFI; ii) an aluminophosphate; iii) a silicoaluminophosphate; or iv) a mesoporous silicate. Suitably, the solid, porous, inorganic oxide-containing framework material is selected from: i) an aluminium silicate with a framework structure selected from zeolite types LTA, FAU or MFI; ii) a microporous aluminophosphate; iii) a microporous silicoaluminophosphate; or iv) a mesoporous silicate selected from MCM-41 (Mobil Composition of Matter No. 41) or SBA-15 (Santa Barbara Amorphous No. 15). More suitably, the solid, porous, inorganic oxide-containing framework material is selected from; i) an aluminium silicate with a framework structure selected from zeolite types FAU or MFI; ii) a microporous aluminophosphate; iii) a microporous silicoaluminophosphate; or iv) a mesoporous silicate selected from MCM-41 (Mobil Composition of Matter No. 41) or SBA-15 (Santa Barbara Amorphous No. 15). Most suitably, the solid, porous, inorganic oxide-containing framework material is selected from; i) an aluminium silicate with a framework structure selected from zeolite types FAU or MFI; ii) a microporous aluminophosphate; or iii) a microporous silicoaluminophosphate.

In further embodiment, the solid, porous, inorganic oxide-containing framework material is selected from a zeolite selected from HY 5.1 or ZSM5-23, the microporous aluminophosphate AIPO5, the microporous silicoaluminophosphate SAPO5, or a mesoporous silicate selected from MCM-41 (Mobil Composition of Matter No. 41) or SBA-15 (Santa Barbara Amorphous No. 15).

### Layered Double Hydroxide (LDH)

The LDH grown on the surface of the solid, porous, inorganic oxide-containing framework material, comprises, and preferably consists of, LDH represented by the general formula (I):

[M^{z+}₁₋ₓM′^{y+}ₓ(OH)₂]^{a+}(Xⁿ⁻)_{a/n}·bH₂O·c(AMO-solvent) (I),

wherein;
M^{z+} is a metal cation of charge z or a mixture of two or more metal cations each independently having the charge z;
M′^{y+} is a metal cation of charge y or a mixture of two or more metal cations each independently having the charge y;
z=1 or 2;
y=3 or 4;
0<x<0.9;
b=0−10;
c=0.01−10;
Xⁿ⁻ is an anion, n is the charge on the anion, n>0 (preferably 1-5);
a=z(1−x)+xy−2; and
AMO-solvent is a >90%, suitably >95%, more suitably >98% and most suitably 100%, aqueous miscible organic solvent.

As stated above, M^{z+} and M′^{y+} are different charged metal cations. M^{z+} is a metal cation of charge z or a mixture of two or more metal cations each independently having the charge z; M′^{y+} is a metal cation of charge y or a mixture of two or more metal cations each independently having the charge y.

Having regard to the fact that z=1 or 2, M will be either a monovalent metal or a divalent metal. M′, in view of the fact that y=3 or 4, will be a trivalent metal or a tetravalent metal.

A preferred example of a monovalent metal, for M, is Li. Examples of divalent metals, for M, include Ca, Mg, Zn, Fe, Co, Cu and Ni and mixtures of two or more of these. Preferably, the divalent metal M, if present, is Ca, Ni or Mg. Examples of metals, for M′, include Al, Ga, In, Y and Fe. Preferably, M′ is Al. Preferably, the LDH will be a Li—Al, an Mg—Al, an Mg—Ni—Al or a Ca—Al LDH.

The anion Xⁿ⁻ in the LDH is any appropriate inorganic or organic anion. Examples of anions that may be used, as Xⁿ⁻, in the LDH include carbonate, hydroxide, nitrate, borate, sulphate, phosphate and halide (F⁻, Cl⁻, Br⁻, I⁻) anions. Preferably, the anion Xⁿ⁻, is selected from CO₃²⁻, NO₃⁻ and Cl⁻.

The AMO-solvent is a >90%, suitably >95%, more suitably >98% and most suitably 100%, aqueous miscible organic solvent. Examples of suitable water-miscible organic solvents for use in the present invention include lower (1-3C) alkanols, and acetone. Preferably, the AMO-solvent is methanol, ethanol, isopropanol or acetone, especially acetone or ethanol.

According to one preferred embodiment, the layered double hydroxides are those having the general formula I above in which:
M^{z+} is a divalent metal cation;
M′^{y+} is a trivalent metal cation; and
each of b and c is a number >zero, which gives compounds optionally hydrated with a stoichiometric amount or a non-stoichiometric amount of water and/or an aqueous-miscible organic solvent (AMO-solvent), such as acetone.

Preferably, in the LDH of the above formula, M is Mg, Ni or Ca and M′ is Al. The counter anion Xⁿ⁻ is typically selected from CO₃²⁻, OH⁻, F⁻, Cl⁻, Br⁻, I⁻, SO₄²⁻, NO₃⁻and PO₄³⁻. In a most preferred embodiment, the LDH will be one wherein M is Mg, M′ is Al and Xⁿ⁻ is CO₃²⁻.

### Particularly Preferred Embodiments

The following represent particular embodiments of the core @ layered double hydroxide:
1.1 The core @ layered double hydroxide materials have the general formula I

Tₚ@{[M^{z+}₍₁₋ₓ₎M′^{y+}ₓ(OH)₂]^{a+}(Xⁿ⁻)_{a/n}·bH₂O·c(AMO-solvent)}_{q} (I)
wherein,
T is a molecular sieve material selected from silicate, aluminium silicate, vanadium silicate, iron silicate, silicon-aluminium phosphate (SAPO) and aluminium phosphate (AIPO), preferably an aluminium silicate having a silicon:aluminium ratio of from 1 to 100, more preferably of 1 to 50, most preferably 1 to 40;
M^{z+} is selected from Li⁺, Ca²⁺, Cu²⁺, Zn²⁺, Ni²⁺ or Mg²⁺, and M′^{y+} is Al³⁺, Ga³⁺, In³⁺ or Fe³⁺;
0<x<0.9;
b is 0 to 10;
c is 0.01 to 10;
p>0,
q>0;
Xⁿ⁻ is selected from carbonate, hydroxide, nitrate, borate, sulphate, phosphate and halide (F⁻, Cl⁻, Br⁻, I⁻) anions; with n>0 (preferably 1-5) a=z(1−x)+xy−2; and
the AMO-solvent is selected from a lower (1-3C) alkanol (e.g. ethanol) or acetone.
1.2 The core @ layered double hydroxide materials have the general formula la

Tₚ@{[M^{z+}₍₁₋ₓ₎M′^{y+}ₓ(OH)₂]^{a+}(Xⁿ⁻)_{a/n}·bH₂O·c(AMO-solvent)}_{q} (la)
wherein,
T is a molecular sieve material selected from silicate, aluminium silicate, vanadium silicate, iron silicate, silicon-aluminium phosphate (SAPO) and aluminium phosphate (AIPO), preferably an aluminium silicate having a silicon:aluminium ratio of from 1 to 100, more preferably of 1 to 50, most preferably 1 to 40;
M^{z+} is selected from Li⁺, Ca²⁺, Cu²⁺, Zn²⁺, Ni²⁺ or Mg²⁺, and M′^{y+} is Al³⁺, Ga³⁺, In³⁺, or Fe³⁺;
0<x<0.9;
b is 0 to 10;
c is 0.01 to 10;
p>0,
q>0;
Xⁿ⁻ is is selected from CO₃²⁻ NO₃⁻ or Cl⁻; with n>0 (preferably 1-5)
a=z(1−x)+xy−2; and
the AMO-solvent is selected from ethanol, isopropanol or acetone.
1.3 The core @ layered double hydroxide materials have the general formula lb

Tₚ@{[M^{z+}₍₁₋ₓ₎M′^{y+}ₓ(OH)₂]^{a+}(Xⁿ⁻⁻⁾_{a/n}·bH₂O·c(AMO-solvent)}_{q} (lb)
wherein,
T is; i) an aluminium silicate with a framework structure selected from zeolite types LTA, FAU, BEA, MOR or MFI; ii) an aluminophosphate; iii) a silicoaluminophosphate; or iv) a mesoporous silicate, wherein the aluminium silicate has a silicon:aluminium ratio of from 1 to 50, more preferably of 1 to 40, most preferably of 1 to 30;
M^{z+} is selected from Li⁺, Ca²⁺, Cu²⁺, Zn²⁺, Ni²⁺ or Mg²⁺, and M′^{y+} is Al³⁺, Ga³⁺, In³⁺ or Fe³⁺;
0<x<0.9;
b is 0 to 10;
c is 0.01 to 10;
p>0,
q>0;
Xⁿ⁻ is is selected from CO₃²⁻ NO3⁻ or Cl⁻; with n>0 (preferably 1-5)
a=z(1 −x)+xy−2; and
the AMO-solvent is selected from ethanol or acetone.
1.4 The core @ layered double hydroxide materials have the general formula lc

Tₚ@{[M^{z+}₍₁₋ₓ₎M′^{y+}ₓ(OH)₂]^{a+}(Xⁿ⁻)_{a/n}·bH₂O·c(ethanol)}_{q} (lc)
wherein,
T is; i) an aluminium silicate with a framework structure selected from zeolite types LTA, FAU, BEA, MOR or MFI; ii) an aluminophosphate; iii) a silicoaluminophosphate; or iv) a mesoporous silicate, wherein the aluminium silicate has a silicon:aluminium ratio of from 1 to 50, more preferably of 1 to 40, most preferably of 1 to 30;
M^{z+} is selected from M^{z+} is selected from Li⁺, Ca²⁺, Cu²⁺, Zn²⁺, Ni²⁺ or Mg²⁺, and M′^{y+} is Al³⁺, Ga³⁺, In³⁺ or Fe³⁺;
0<x<0.9;
b is 0 to 10;
c is 0.01 to 10;
p>0,
q>0;
Xⁿ⁻ is is selected from CO₃²⁻, NO₃⁻ or Cl⁻; with n>0 (preferably 1-5)
a=z(1−x)+xy−2.
1.5 The core @ layered double hydroxide materials have the general formula ld

Tₚ@{[M^{z+}₍₁₋ₓ₎M′^{y+}ₓ(OH)₂]^{a+}(Xⁿ⁻)_{a/n}·bH₂O·c(ethanol)}_{q} (ld)
wherein,
T is; i) an aluminium silicate with a framework structure selected from zeolite types LTA, FAU or MFI; ii) an aluminophosphate; iii) a silicoaluminophosphate; or iv) a mesoporous silicate, wherein the aluminium silicate has a silicon:aluminium ratio of from 1 to 50, more preferably of 1 to 40, most preferably of 1 to 30;
M^{z+} is selected from Li⁺, Ca²⁺, Ni²⁺ or Mg²⁺, and M′^{y+} is Al³⁺ or Fe³⁺;
0<x<0.9;
b is 0 to 10;
c is 0.01 to 10;
p>0,
q>0;
Xⁿ⁻is is selected from CO₃²⁻ or NO₃⁻; with n>0 (preferably 1-5)
a=z(1−x)+xy−2.

Preferred, suitable, and optional features of any one particular aspect of the present invention are also preferred, suitable, and optional features of any other aspect.

### Process of the Present Invention

The core @ LDH shell material of the invention, as described above, may be prepared by a method which comprises the steps:
(a) contacting a metal ion-containing solution containing metal ions M^{z+} and M′^{y+} and particles of the framework material in the presence of a base and an anion solution; and
(b) optionally treating the product with AMO-solvent and recovering the solvent treated material to obtain the core @ LDH material.

In a particular embodiment, core @ LDH shell material of the invention, as described above, may be prepared by a method which comprises the steps:
(a) contacting a metal ion-containing solution containing metal ions M^{z+} and M′^{y+} and particles of the framework material in the presence of a base and an anion solution; and
(b) treating the product with AMO-solvent and recovering the solvent treated material to obtain the core @ LDH material.

In carrying out the method of the invention, preferably porous, inorganic framework material particles are dispersed in an aqueous solution containing the desired anion salt, for example, Na₂CO₃. This aqueous solution containing one or more anionic salts (e.g. Na₂CO₃) will be understood to be the anionic solution described herein. A metal precursor solution, i.e. a solution combining the required monovalent or divalent metal cations and the required trivalent cations may then be added, preferably drop-wise, into the dispersion of the core material particles. Preferably, the addition of the metal precursor solution is carried out under stirring. The pH of the reaction solution is preferably controlled within the pH range 8 to 12, typically 8 to 11, more preferably 9 to 10. Typically, NaOH may be used to adjust the pH of the solution.

During the reaction, the LDH produced from the metal precursor solution reaction is formed on the surfaces of the core material particles as nanosheets.

Without wishing to be bound by theory, it is believed that a small amount of aluminium leaching from the porous, inorganic framework material allows the seeded growth of the LDHs on to their surface.

It is preferred that the temperature of the metal ion containing solution in step (a) is within a range of from 20 to 150° C., preferably from 20 to 80° C., more preferably from 20 to 50° C. and most preferably from 20 to 40° C.

The obtained solid product is collected from the aqueous medium. Examples of methods of collecting the solid product include centrifugation and filtration. Typically, the collected solid may be re-dispersed in water and then collected again.

The finally-obtained solid material may then be subjected to drying, for instance, in an oven for several hours.

In the event that a product containing AMO-solvent is required, the material obtained after the collection/re-dispersion procedure described above may be washed with, and preferably also re-dispersed in, the desired aqueous miscible organic (AMO) solvent, for instance acetone. If re-dispersion is employed, the dispersion is preferably stirred. Stirring for more than 2 hours in the solvent is preferable. The final product may then be collected from the solvent and then dried, typically in an oven for several hours.

The growth of LDH nanosheets on the surface of the framework particles is “tuneable”. That is to say, by varying the chemistry of the precursor solution, the pH of the reaction medium and the rate of addition of the precursor solution to the dispersion of framework particles, the extent of, and the length and/or thickness of, the LDH nanosheets formed on the framework particle surfaces can be varied.

In another aspect of the present invention, there is provided a core @ layered double hydroxide shell material obtainable by, obtained by, or directly obtained by the process described hereinabove.

The core @ LDH shell materials of the invention may be used as catalysts and/or catalyst supports.

### Core @ Mixed Metal Oxide Materials

The inventors additionally found that when the core @ layered double hydroxide shell materials of the present invention are subjected to calcination, the layered double hydroxide undergoes water loss followed by decomposition to produce core @ mixed metal oxide materials which have use as catalyst supports and sorbents. These core @ mixed metal oxide materials are represented by the formula

Tₚ@{[M^{z+}₁₋ₓM′y+ₓO_{w}]ₚŸ]
wherein T is a solid, porous, inorganic oxide-containing framework material, M^{z+}₁₋ₓM′^{y+}ₓO_{w} is a mixed metal oxide, or mixture of mixed metal oxides, which may be crystalline or non-crystalline, wherein M^{z+} and M′^{y+} are different charged metal cations; M^{z+} is a metal cation of charge z or a mixture of two or more metal cations of charge z; M′^{y+} is a metal cation of charge y or a mixture of two or more metal cations of charge y; z is 1 or 2; y is 3 or 4; 0<x<0.9; w>0; p>0 and q>0. Ÿ is the residue of the Xⁿ⁻ anion after calcination.

Accordingly, in a further aspect, the present invention provides the core @ mixed metal oxide materials represented by the formula given above. According to a yet further aspect, the present invention provides a method of making core @ mixed metal oxide materials having the formula

Tₚ@{[M^{z+}₁₋ₓM′^{y+}ₓO_{w}]ₚŸ]
wherein T is a solid, porous, inorganic oxide-containing framework material as defined earlier, M^{z+}₁₋ₓM′^{y+}ₓO_{w} is a mixed metal oxide or a mixture of mixed metal oxides, which may be crystalline or non-crystalline, wherein M^{z+} and M′^{y+} are different charged metal cations; M^{z+} is a metal cation of charge z or a mixture of two or more metal cations of charge z; M′^{y+} is a metal cation of charge y or a mixture of two or more metal cations of charge y; z is 1 or 2; y is 3 or 4; 0<x<0.9; w>0; p>0 and q>0, and Ÿ is the residue of an anion Xⁿ⁻ defined below after heat treatment, which method comprises subjecting a core @ layered double hydroxide shell material having the formula

Tₚ@{[M^{z+}₍₁₋ₓ₎M′ₓ^{y+}(OH)₂]^{a+}(Xⁿ⁻)_{a/n}·bH₂O·c(AMO-solvent)}_{q}
wherein T is a solid, porous, inorganic oxide-containing framework material, M^{z+} is a metal cation of charge z or a mixture of two or more metal cations of charge z; M′^{y+} is a metal cation of charge y or a mixture of two or more metal cations of charge y;
z=1 or 2;
y=3 or 4;
0<x<0.9;
b is 0 to 10;
c is 0.01 to 10;
p>0;
q>0;
Xⁿ⁻ is an anion; with n>0;
a=z(1−x)+xy−2; and
AMO-solvent is an 100% aqueous miscible organic solvent, to heat treatment.

The term heat treatment may be used interchangeably with the term calcined, and both refer to subjecting the core @ layered double hydroxide to heat, which results in a loss of moisture and/or a reduction and/or an oxidation and/or the decomposition of the core @ layered double hydroxide material.

Preferably, the core @ layered double hydroxide shell material is calcined at a temperature in the range of 100° to 1000° C., preferably in the range of 250° to 750° C. and more preferably in the range of 400° to 550° C. The heat treatment will typically be carried out in air or under nitrogen, oxygen, argon or hydrogen, suitably in air or under nitrogen or hydrogen.

### FIGURES

FIG. 1. TEM images of (a) zeolite HY5.1 and (b) HY5.1 @ AMO-LDH

FIG. 2. Thermal analysis data for the zeolite @ layered double hydroxide shell material (HY5.1 @ AMO-LDH) showing the thermal events on heating.
Left—Thermogravimetric Analysis (TGA), where (a) is HY 5.1, (b) is HY 5.1 @ LDA-A and (c) is LDH-A.
Right—derivative Thermogravimetric Analysis (dTGA), where (a) is HY 5.1, (b) is HY 5.1 @ LDA-A and (c) is LDH-A.
LDH-A denotes AMO-synthesised LDH using acetone treatment.

FIG. 3. Pore size distribution of HY5.1 and HY5.1 @ AMO-LDH after calcination at 300° C., where (a) is HY5.1 and (b) is HY5.1 @ LDH-A and LDH-A denotes AMO-synthesised LDH.

FIG. 4. TEM images of HY5.1 @ LDH top shows water-washed product bottom shows acetone-washed product LDH-W denotes conventionally-synthesised LDH, LDH-A denotes AMO-synthesized LDH.

FIG. 5. X-ray powder diffraction of HY5.1 @ LDH

Left—a comparison with starting material, where (a) is HY5.1, (b) is HY5.1 @ LDH-A and (c) is LDH-A.
Right—a comparison between water- and acetone-washed samples, where (a) is HY5.1 @ LDH-W and (b) is HY5.1 @ LDH-A. LDH-W denotes conventionally synthesised LDH, LDH-A denotes AMO-synthesised LDH.

FIG. 6. Thermal analysis data for the zeolite @ layered double hydroxide shell material, HY5.1 @ LDH, showing the thermal events on heating.
Left—Thermogravimetric Analysis (TGA), where the solid line is HY(5.1) @ LDH-W and the dashed line is HY(5.1) @ LDH-A.
Right—derivative Thermogravimetric Analysis (dTGA), where the solid line is HY(5.1) @ LDH-W and the dashed line is HY(5.1) @ LDH-A.
LDH-W denotes conventionally-synthesised LDH, LDH-A denotes AMO-synthesised LDH with acetone treatment.

FIG. 7. TEM images of HY @ AMO-LDH. AMOST method treatment using acetone as the AMO solvent.

FIG. 8. TEM images of HY30 @ AMO-LDH. AMOST method treatment using acetone as the AMO solvent.

FIG. 9. TEM images of HY15 @ AMO-LDH. AMOST method treatment using acetone as the AMO solvent.

FIG. 10. TEM images of ZSM5 @ AMO-LDH. AMOST method treatment using acetone as the AMO-solvent.

FIG. 11. TEM images of ZSM5-23 @ LDH at a rate of 60 ml/hr drop rate.

FIG. 12. TEM images of ZSM5-40 @ LDH at rates of 60 ml/hr, 40 ml/hr and 20 ml/hr drop rates.

FIG. 13. Thermal analysis data for the zeolite @ layered double hydroxide shell material, ZSM5-23 @ LDH, showing the thermal events on heating.
Left—Thermogravimetric Analysis (TGA), where the solid line is LDH-A, the dashed line is ZSM-5(23) @ LDH-A and the dotted line is ZSM-5(23).
Right—derivative Thermogravimetric Analysis (dTGA), where the solid line is LDH-A, the dashed line is ZSM-5(23)@LDH-A and the dotted line is ZSM-5(23).
AMOST method treatment using acetone as the AMO-solvent. LDH-A denotes AMO-synthesised LDH using acetone treatment.

FIG. 14. Thermal analysis data for the zeolite @ layered double hydroxide shell material, ZSM5-23 @ LDH,
Left—acetone-washed, where the squared line is ZSM-5(23), the circled line is ZSM-5(23) @ LDH-A and the triangular line is LDH-A
Right—water-washed, where the squared line is ZSM-5(23), the circled line is ZSM-5(23) @ LDH-W and the triangular line is LDH-W
LDH-A denotes AMO-synthesised LDH using acetone treatment and LDH-W denotes conventionally synthesised LDH.

FIG. 15. Represents the different BET values at various calcination temperatures using HY5.1 @ LDH demonstrating no particular change.

FIG. 16. TEM image of HY5.1 @ Mg₂Al—NO₃LDH-A. LDH-A denotes AMO-synthesised LDH,
left—1 μm scale zoom
right—500 nm scale zoom.

FIG. 17. X-Ray powder diffraction of HY5.1 @ Mg2A1-NO3 LDH-A. LDH-A denotes AMO-synthesised LDH.

FIG. 18. Thermogravimetric Analysis (TGA) of (a) HY5.1, (b) HY5.1 @ Mg₂Al—NO₃ LDH-A and (c) LDH-A. LDH-A denotes AMO-synthesised LDH.

FIG. 19. Two TEM images of HY5.1 @ Mg₂Al_{0.8}Fe_{0.2}—CO₃ LDH-A. LDH-A denotes AMO-synthesised LDH.

FIG. 20. X-Ray powder diffraction of HY5.1 @ Mg₂Al_{0.8}Fe_{0.2}—CO₃ LDH-A. LDH-A denotes AMO-synthesised LDH.

FIG. 21. Thermogravimetric Analysis (TGA) of (a) HY5.1, (b) HY5.1@ Mg₂Al_{0.8}Fe_{0.2}—CO₃ LDH-A and (c) LDH-A. LDH-A denotes AMO-synthesised LDH.

FIG. 22. Two TEM images of HY5.1 @ Mg_{1.8}AlNi_{0.2}—CO₃ LDH-A. LDH-A denotes AMO-synthesised LDH.

FIG. 23. X-Ray powder diffraction of HY5.1 @ Mg_{1.8}AlNi_{0.2}—CO₃ LDH-A. LDH-A denotes AMO-synthesised LDH.

FIG. 24. Thermogravimetric Analysis (TGA) of (a) HY5.1, (b) HY5.1 @ Mg_{1.8}AlNi_{0.2}—CO₃ LDH-A and (c) LDH-A. LDH-A denotes AMO-synthesised LDH.

FIG. 25. X-Ray powder diffraction of MSN @ LDH (a) MCM-41 @ AMO-LDH (b) SBA-15 @ AMO-LDH.

FIG. 26. TEM images of (a, b) MCM-41 @ AMO-LDH and (c, d) SBA-15 @ AMO-LDH.

FIG. 27. X-Ray powder diffraction of Microporous Aluminophosphate @ LDH: (a)ALPO-5 @ AMO-LDH, (b)SAPO-5 @ AMO-LDH.

FIG. 28. Two TEM images of SAPO-5 @ AMO-LDH.

FIG. 29. Two TEM images of ALPO-5 @ AMO-LDH.

### EXAMPLES

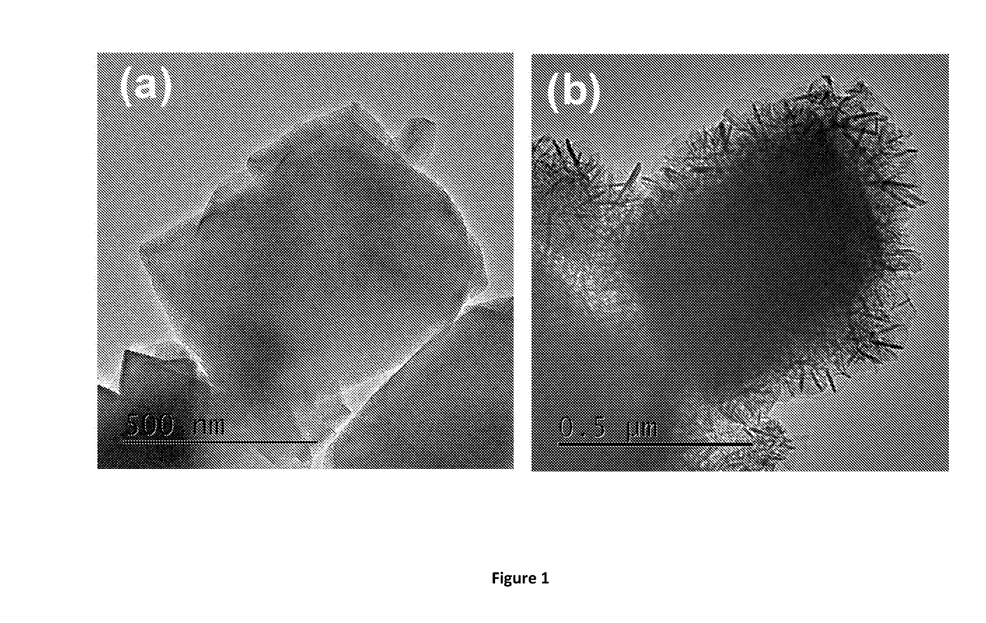

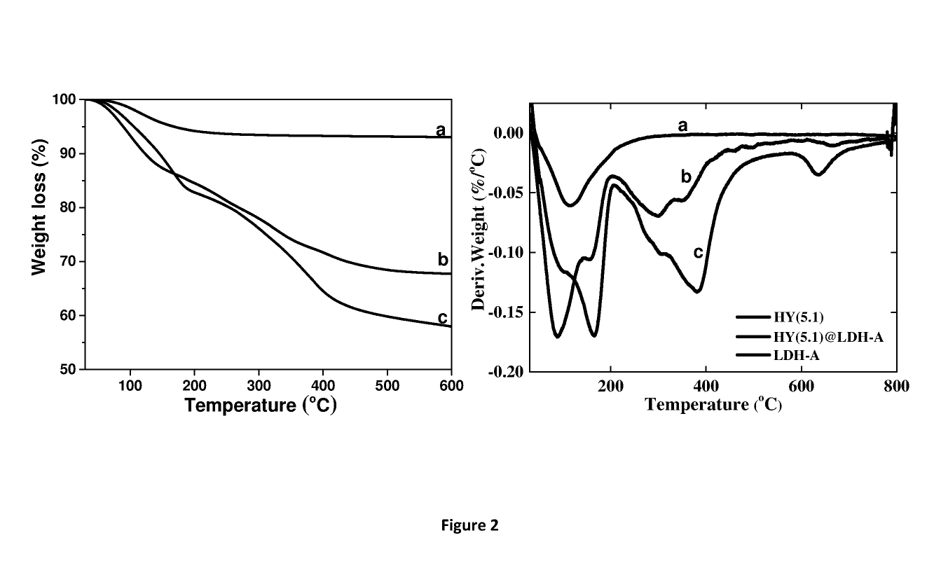

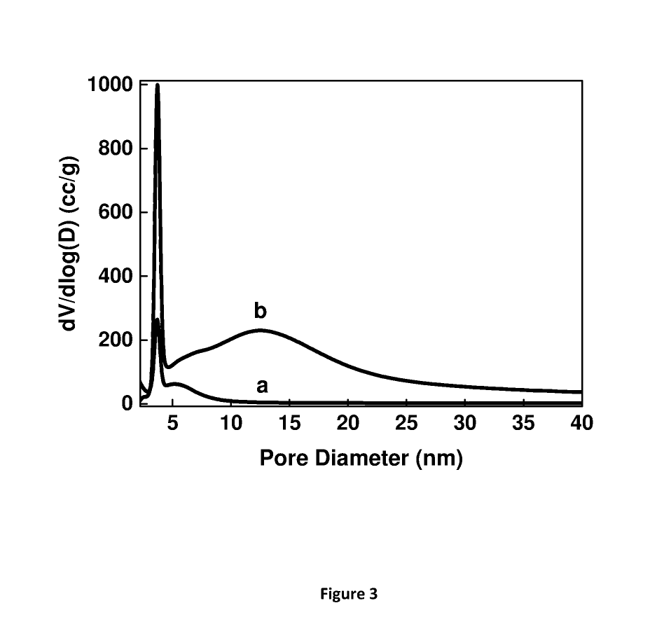

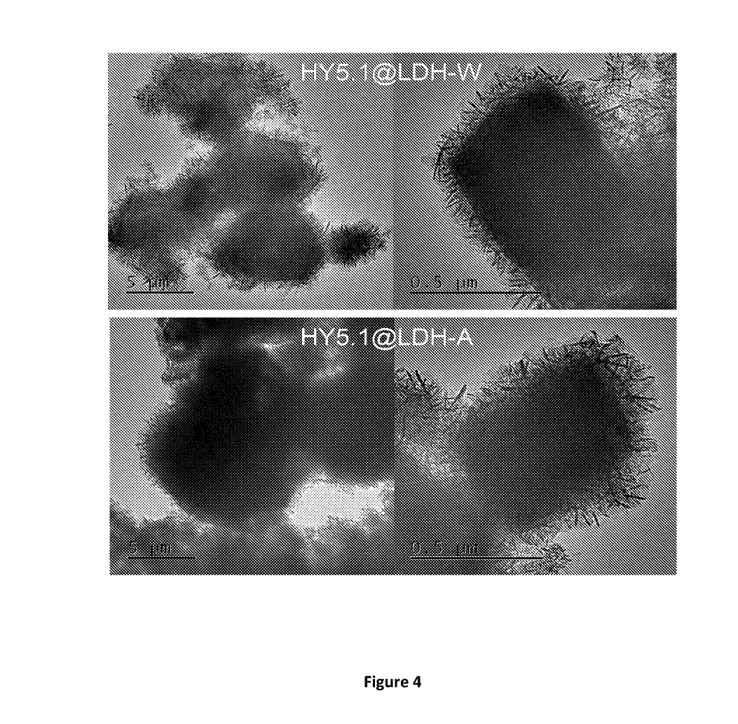

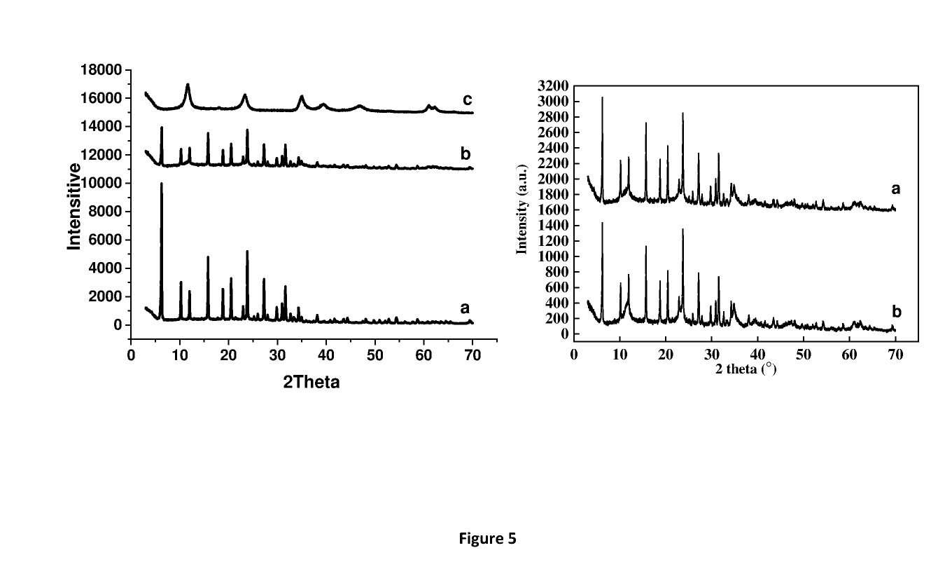

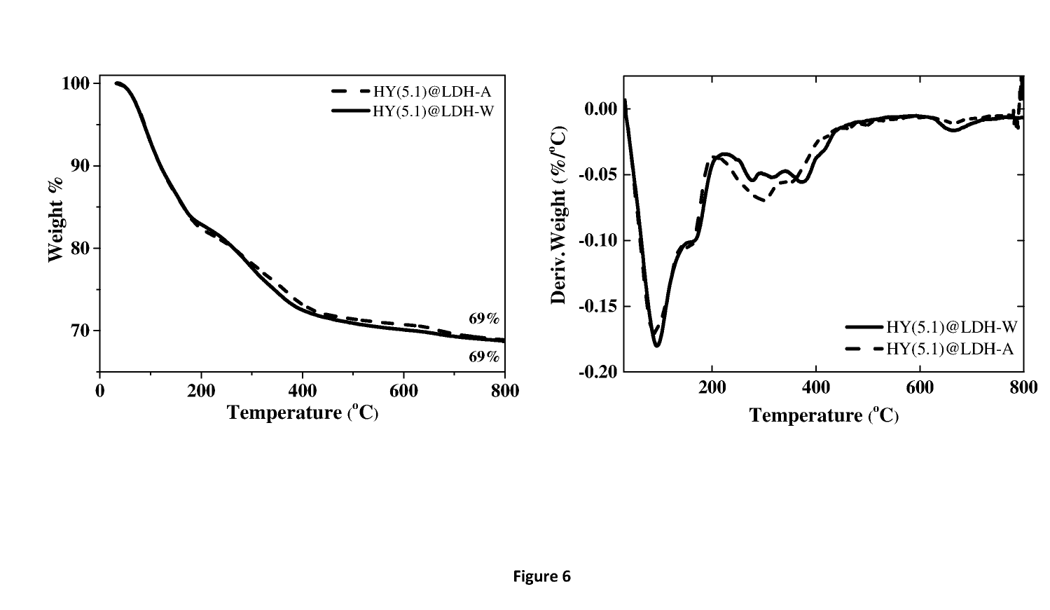

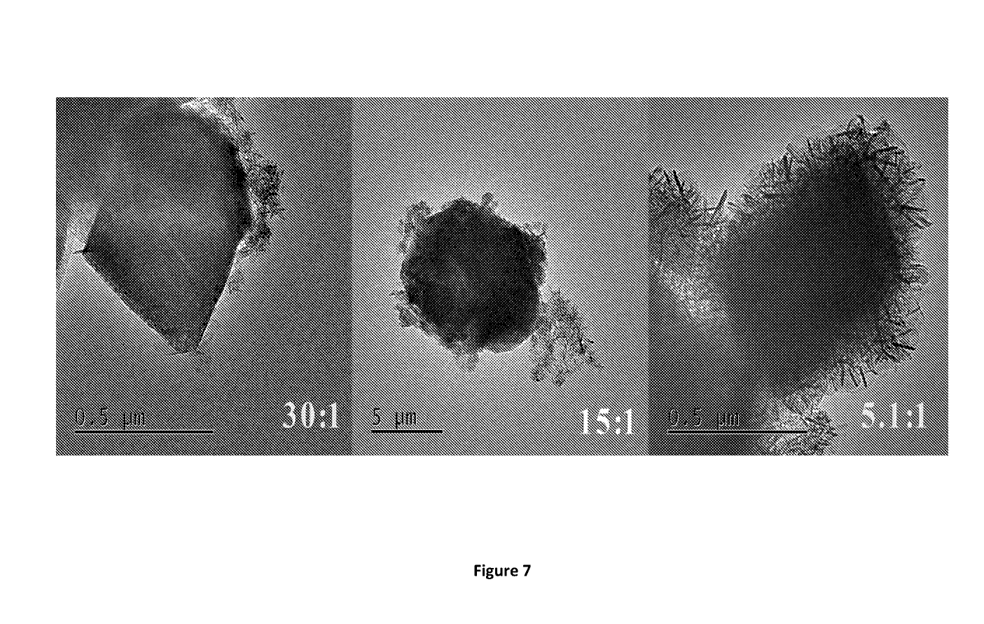

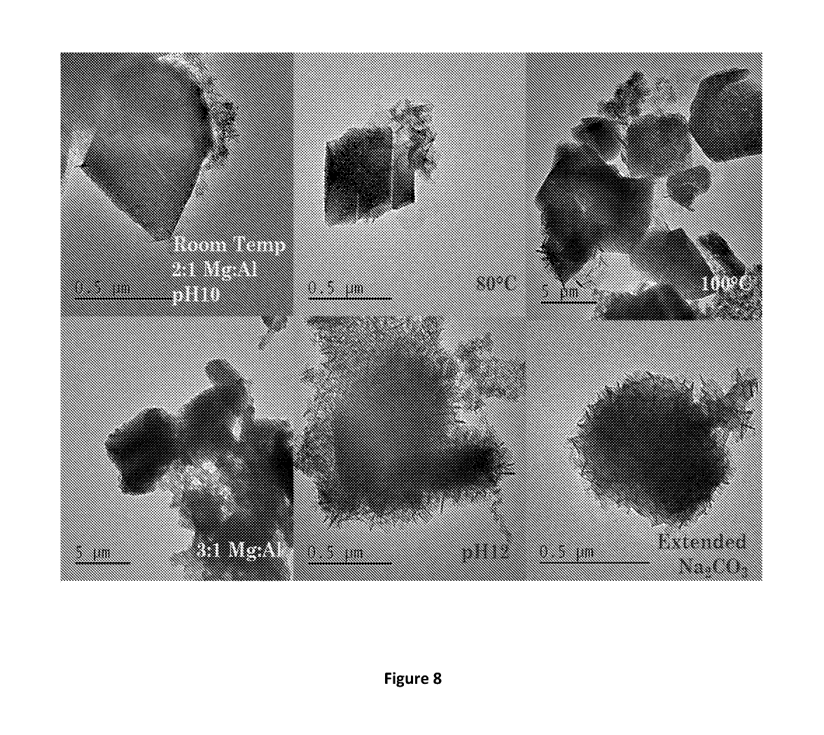

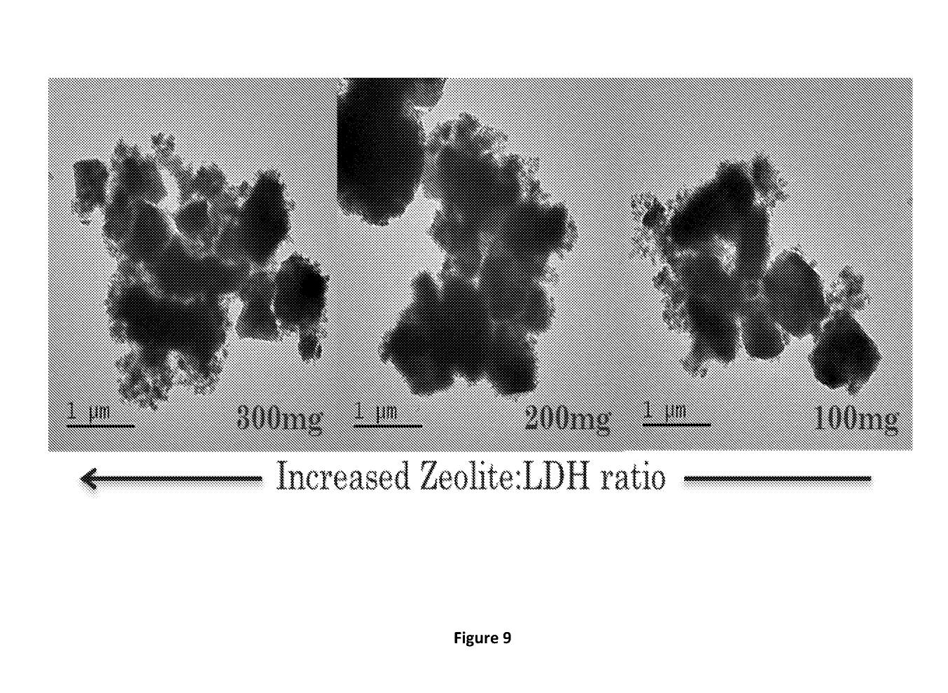

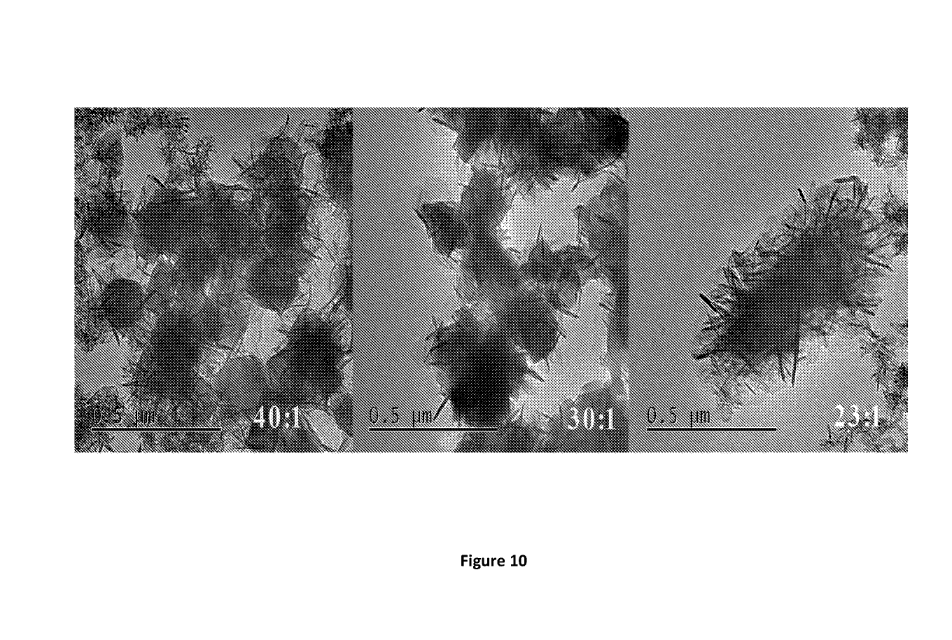

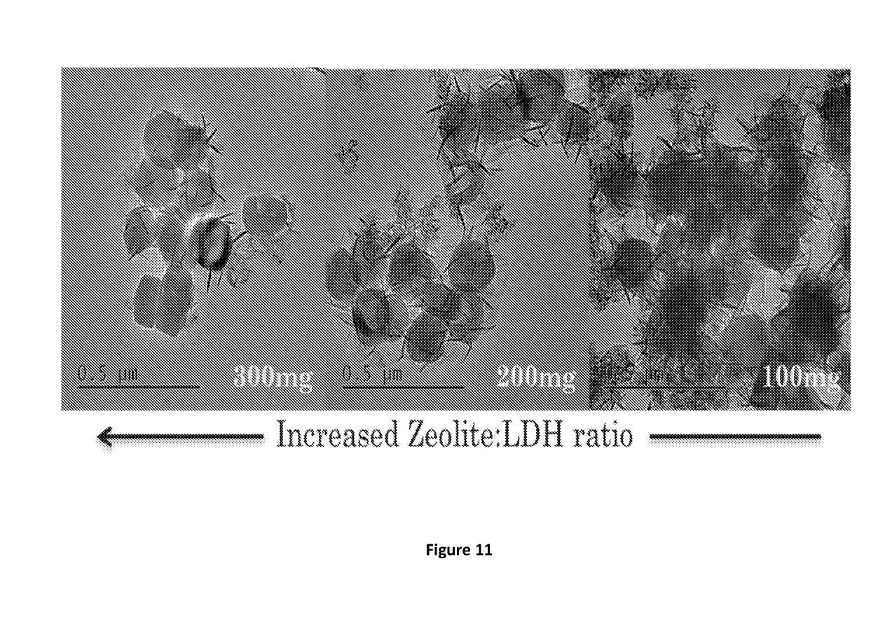

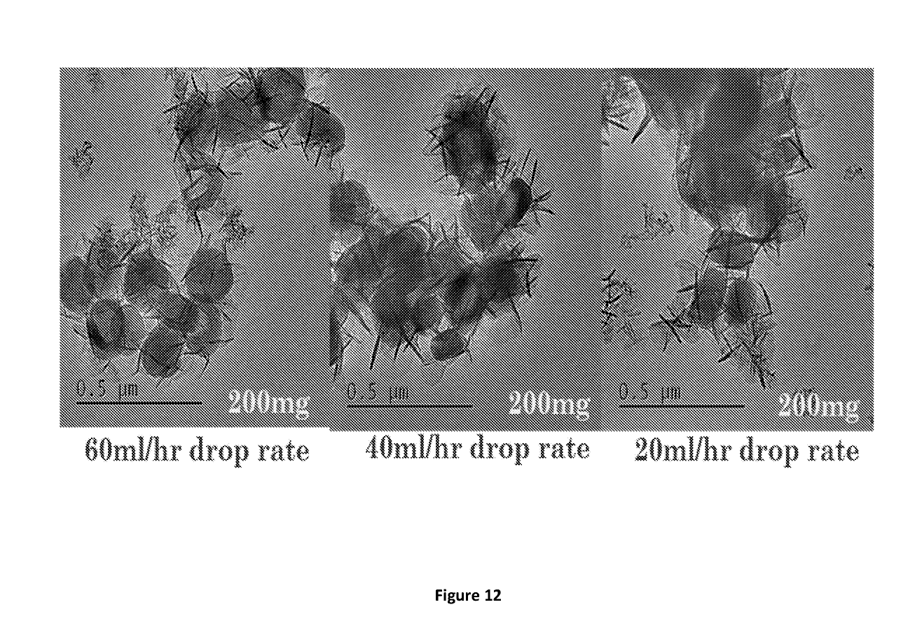

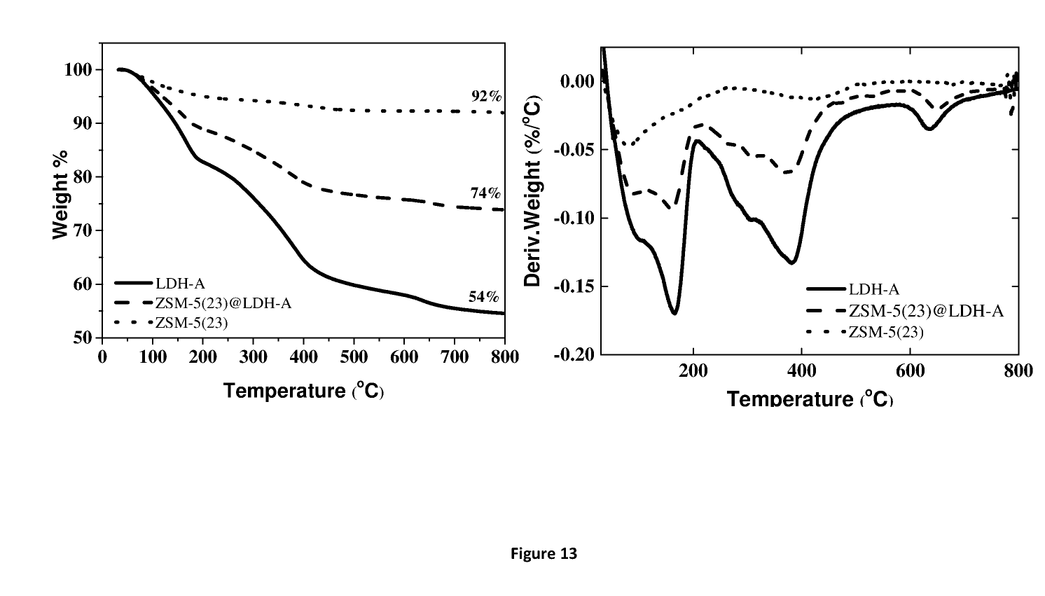

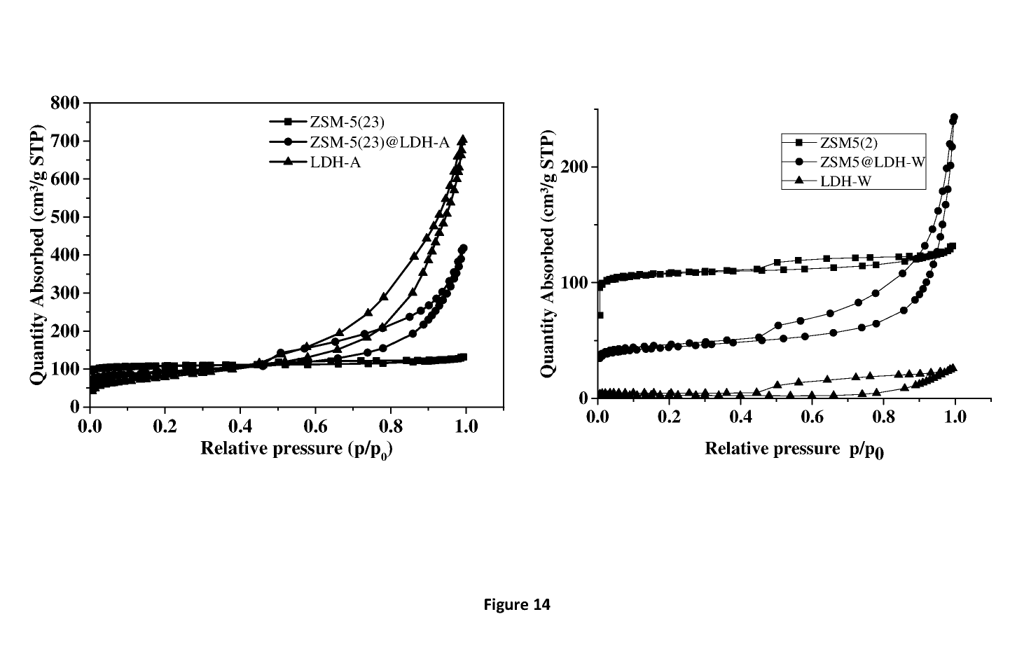

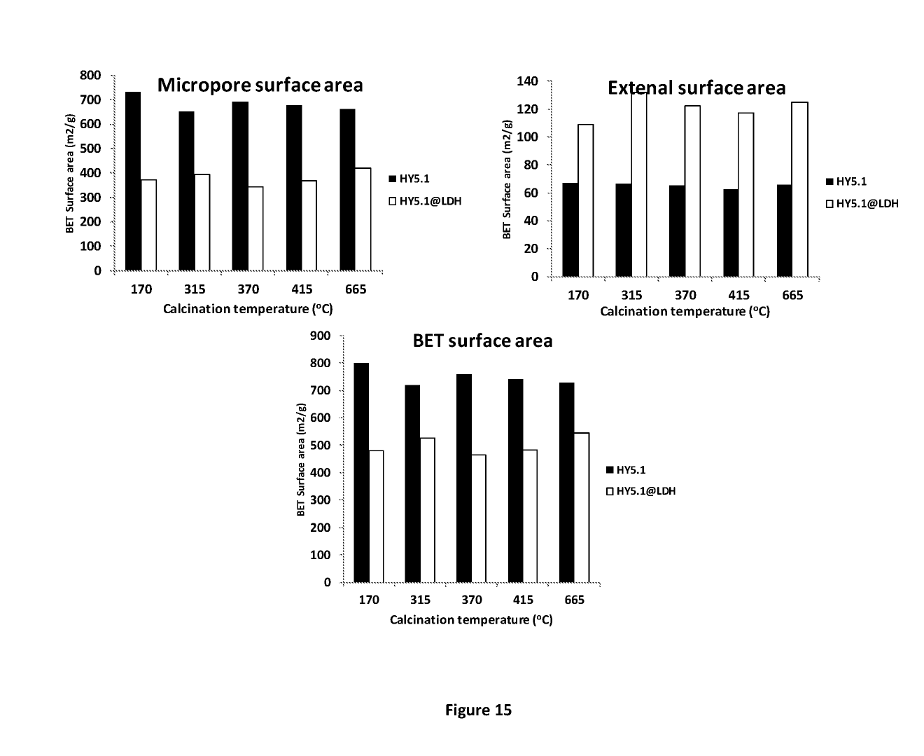

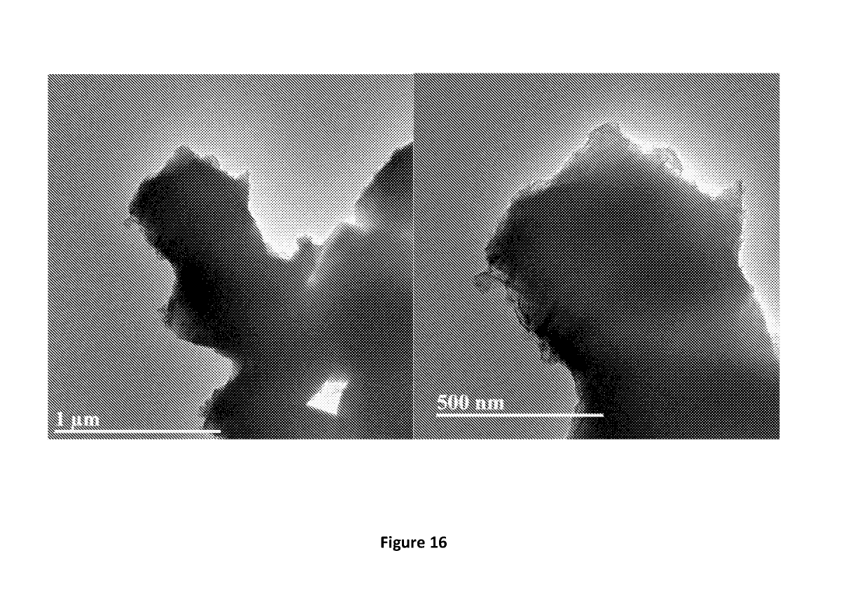

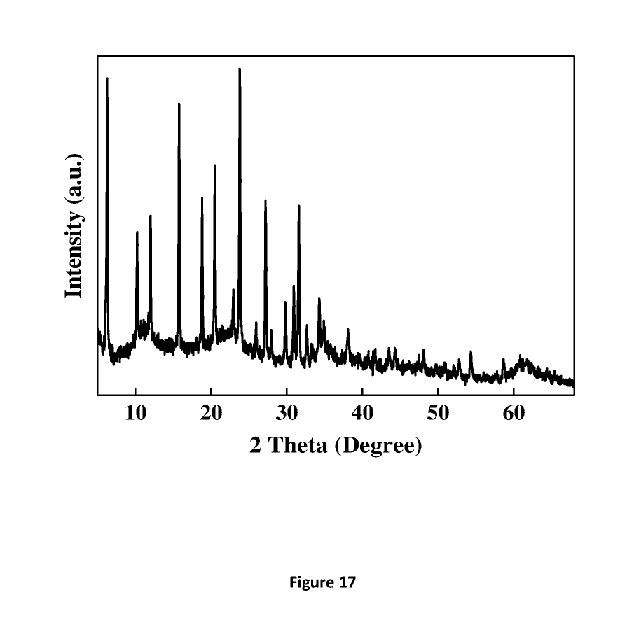

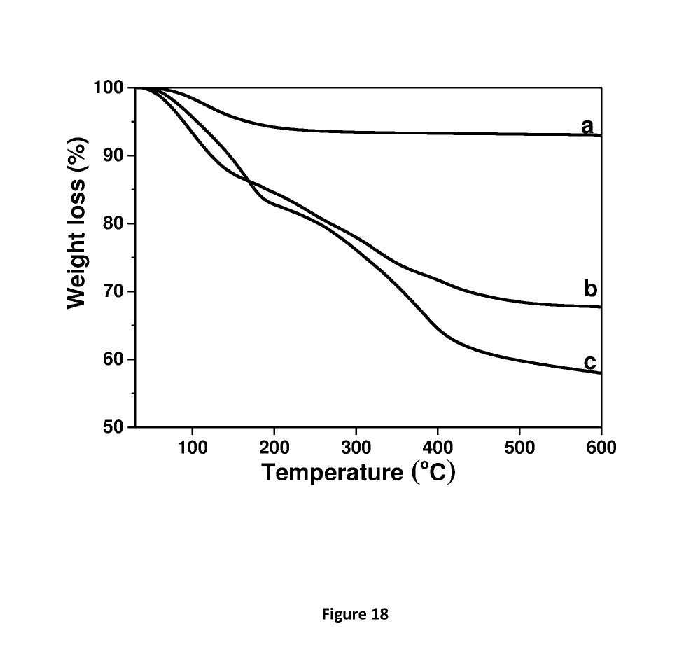

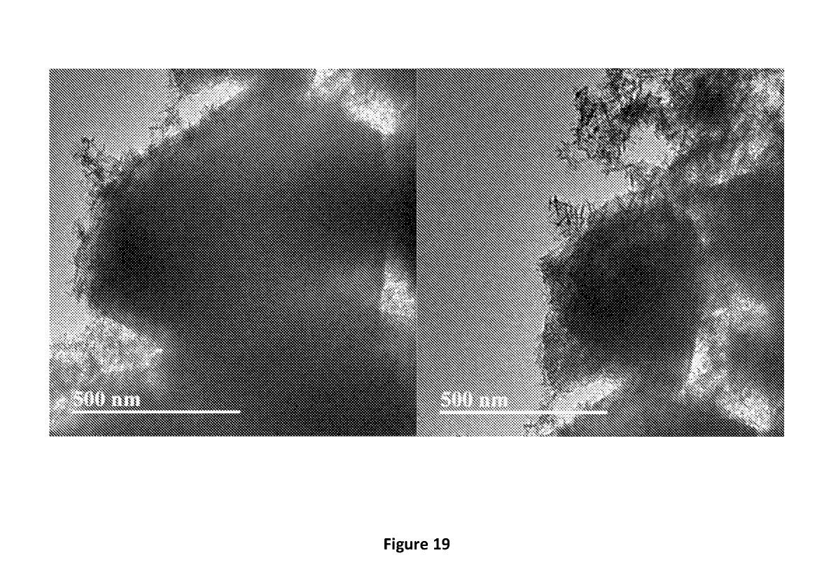

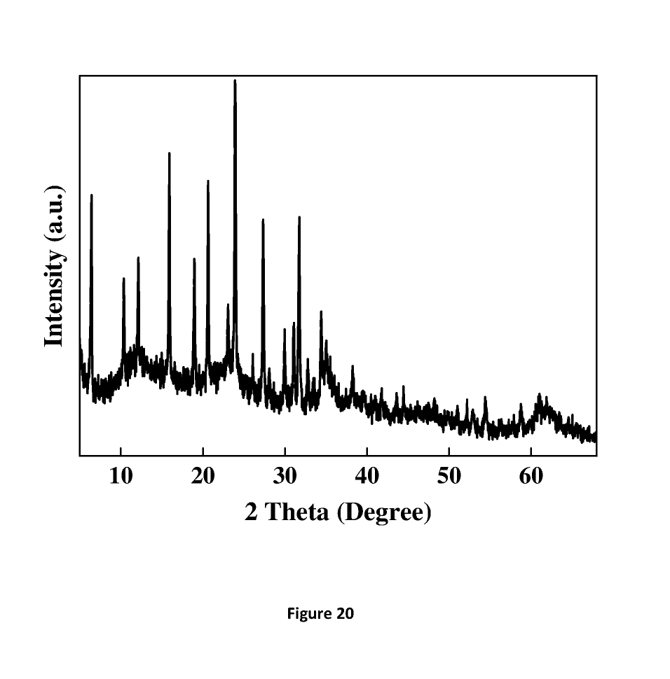

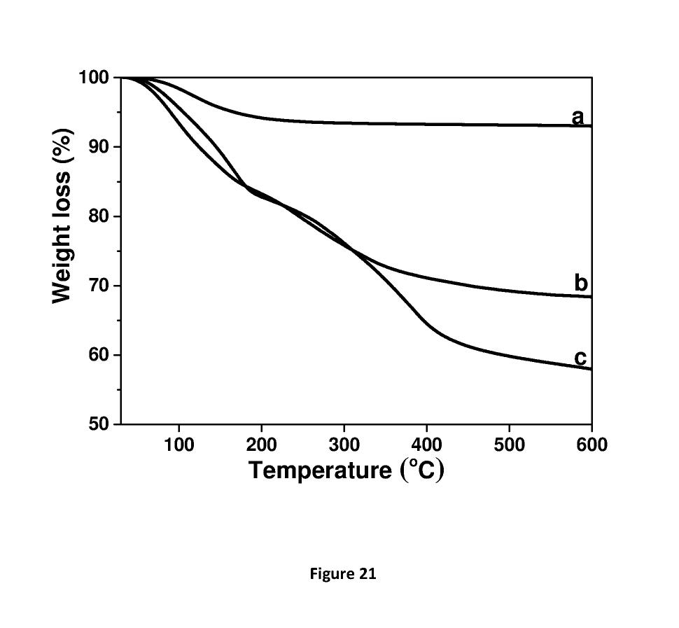

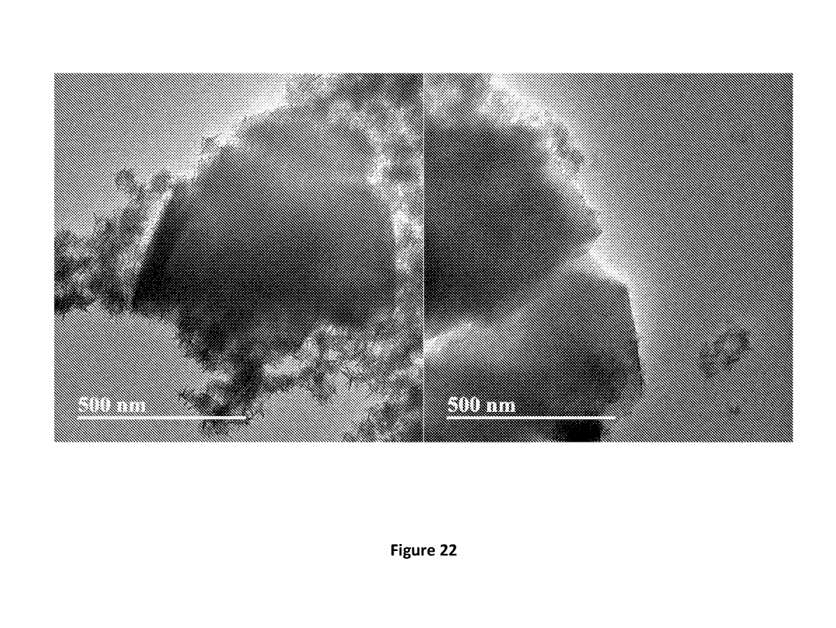

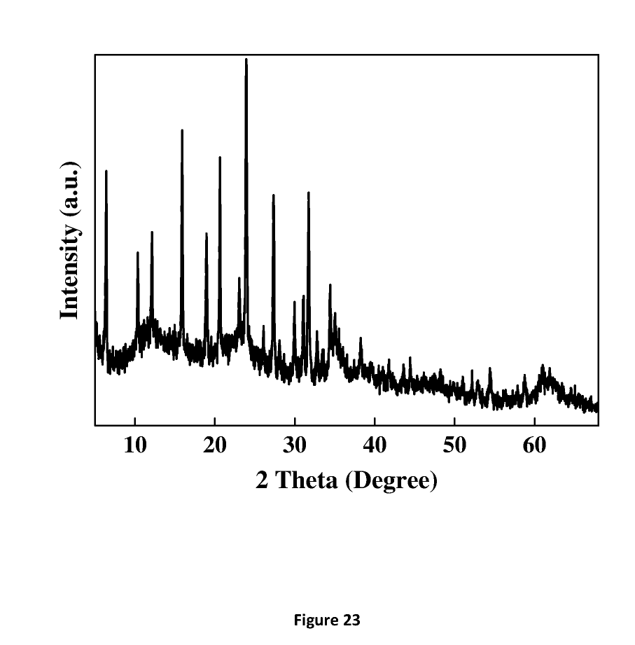

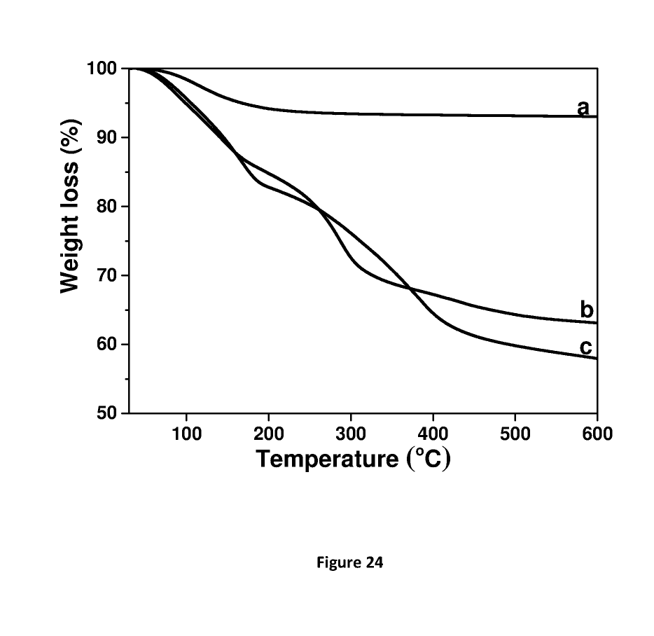

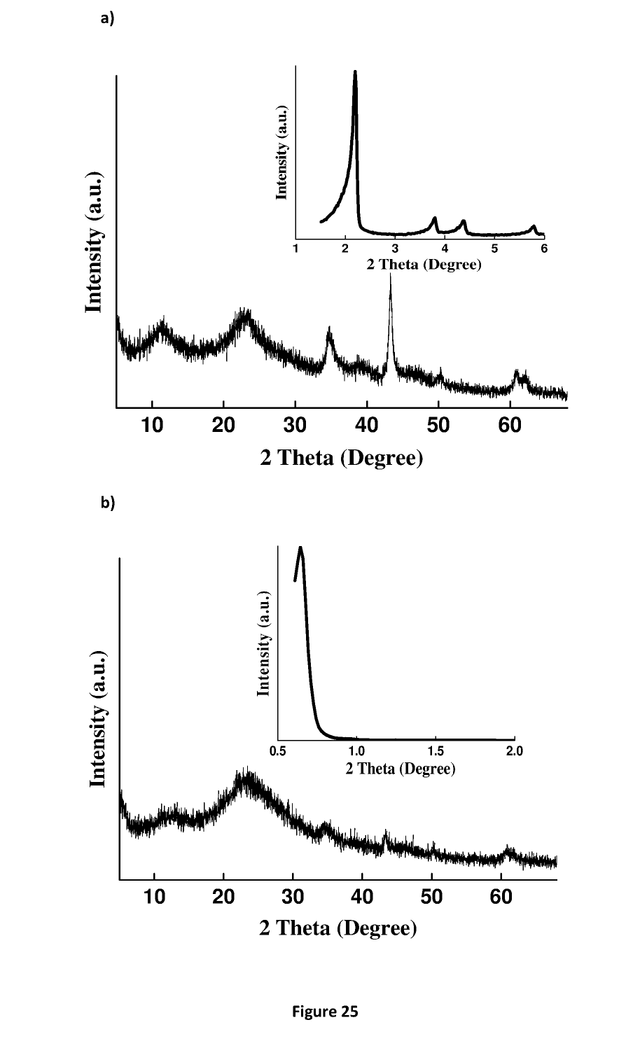

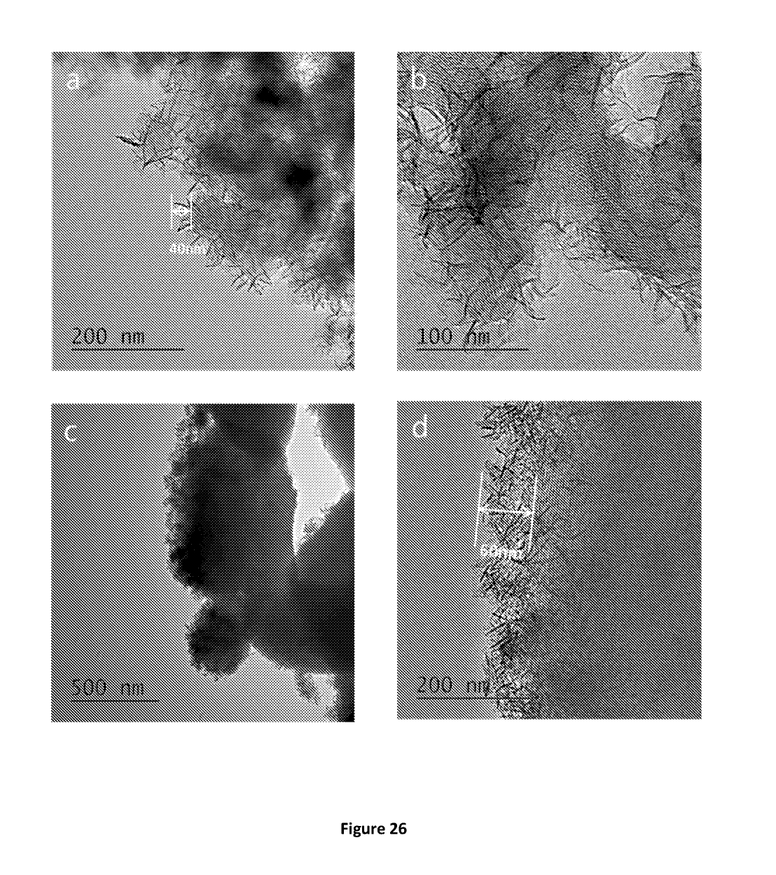

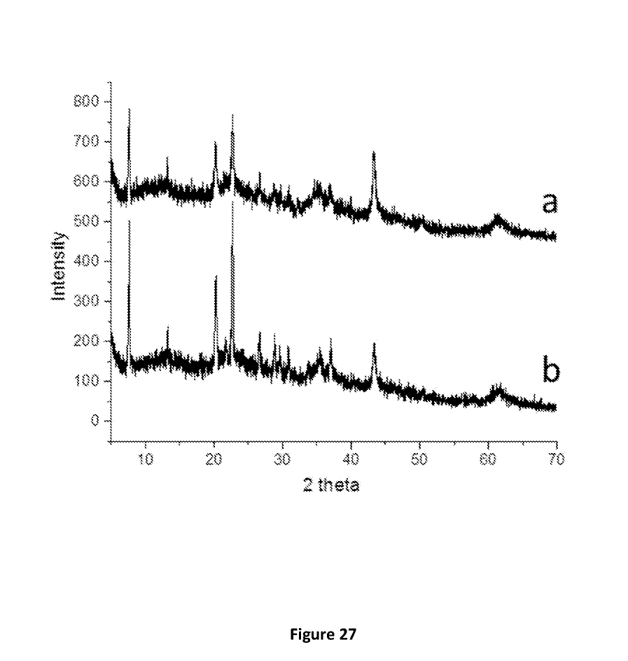

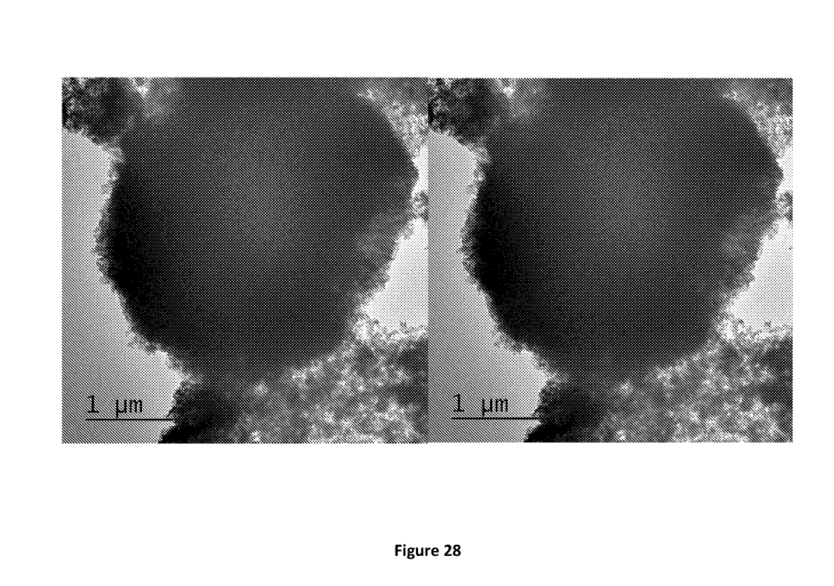

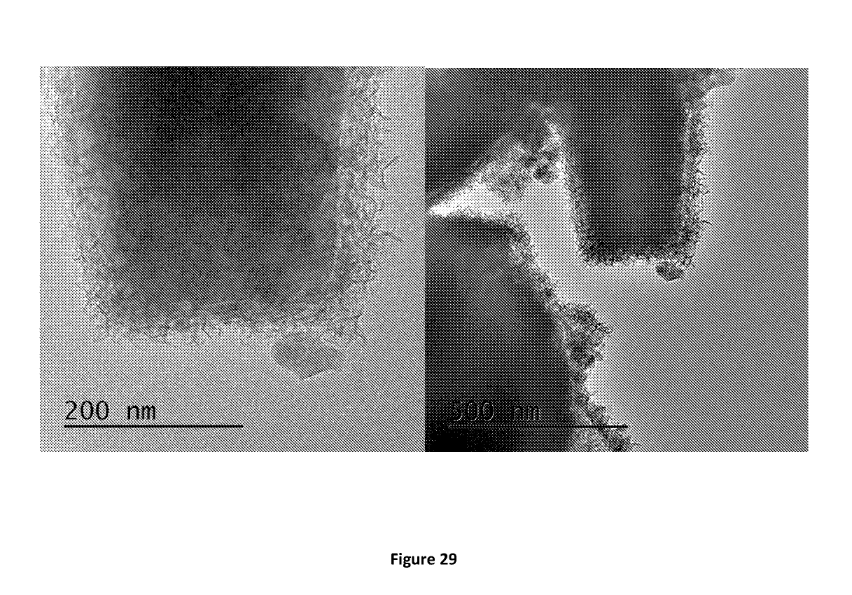

Experimental Methods
1. General Details
1.1 Powder X-Ray Diffraction
Powder X-ray diffraction (XRD) data were collected on a PANAnalytical X′Pert Pro diffractometer in reflection mode and a PANAnalytical Empyrean Series 2 at 40 kV and 40 mA using Cu Kα radiation (α1=1.54057 Å, α2=1.54433 Å, weighted average=1.54178 Å). Scans were recorded from 5°≤0 ≤70° with varying scan speeds and slit sizes. Samples were mounted on stainless steel sample holders. The peaks at 43-44° are produced by the XRD sample holder and can be disregarded.
1.2 Thermogravimetric Analysis
Thermogravimetric analysis (TGA) measurements were collected using a Netzsch STA 409 PC instrument. The sample (10-20 mg) was heated in a corundum crucible between 30° C. and 800° C. at a heating rate of 5° C. min⁻¹ under a flowing stream of nitrogen.
1.3 Transmission Electron Microscopy
Transmission Electron Microscopy (TEM) analysis was performed on a JEOL 2100 microscope with an accelerating voltage of 200 kV. Particles were dispersed in water or ethanol with sonication and then cast onto copper grids coated with carbon film and left to dry.
1.4 Brunauer-Emmett-Teller Surface Area Analysis
Brunauer-Emmett-Teller (BET) specific surface areas were measured from the N₂ adsorption and desorption isotherms at 77 K collected from a Quantachrome Autosorb surface area and pore size analyser.
General Method of Synthesis
Zeolite was dispersed in deionised water using ultrasound treatment. After 30 minutes, sodium carbonate was added to the solution and a further 6 minutes of sonication was carried out to form solution A. An aqueous solution containing magnesium nitrate hexahydrate and aluminium nitrate nonahydrate was added at a rate to solution A under vigour stirring. The pH of the reaction solution was controlled with the addition of 1 M NaOH by an autotitrator. The obtained suspension was stirred for 1 h. Optionally, the obtained solid was collected and then re-dispersed in deionised water and stirred for 1h. The samples (Zeolite @ LDH) were then dried under vacuum. The Zeolite @ AMO-LDH was synthesized using the same procedure. However, before final isolation, the solid was treated with AMOST method, which was washed with acetone and then re-dispersed in a fresh acetone under stirring for certain time. The solid was then dried under vacuum for materials characterization.
Using this general method, zeolite @ LDH shell materials were synthesised using the different zeolite types HY5.1, HY30, HY15, syn-ZSM5, ZSM5-23 and ZSM5-40.
Experimental Methods
Example Method of HY5.1 @ LDH
HY5.1 (100 mg) was dispersed in deionised water (20 mL) using ultrasound treatment. After 30 minutes, sodium carbonate was added to the solution and a further 6 minutes of sonication was carried out to form solution A. An aqueous solution (19.2 mL) containing magnesium nitrate hexahydrate and aluminium nitrate nonahydrate was added at a rate of 60 ml/h to solution A under vigour stirring. The pH of the reaction solution was controlled with the addition of 1 M NaOH by an autotitrator. The obtained suspension was stirred for 1 h. Optionally, the obtained solid was collected and then re-dispersed in deionised water (40 mL) and stirred for 1 h. The collection and re-dispersion was repeated once. The samples (HY5.1 @ LDH) were then dried under vacuum. The HY5.1 @ AMO-LDH was synthesized using the same procedure. However, before final isolation, the solid was treated with AMOST method, which was washed with acetone (40 mL) and then re-dispersed in a fresh acetone (40 mL) under stirring for overnight. The solid was then dried under vacuum for materials characterization.
The zeolite @ LDH shell materials obtained using these different zeolite types were characterised and/or studied according to the following.
Characterisation of HY5.1 @ LDH
The zeolite HY5.1 was used to attempt the synthesis of the first Zeolite @ AMO-LDH. FIGS. 1 and 2 highlight the synthesis and characterisation of HY5.1 @ AMO-LDH. Acetone was used as the AMO-solvent. The AMO-LDH can fully coat the surface of HY5.1 with open hierarchical structure. The content of LDH is around 61.5% according to the TGA result. After thermal treatment at 300° C., the total surface area of HY5.1 @ AMO-LDH is similar to that of pure HY5.1 as shown in Table 1. The external surface area increased close to three times (70 to 201 m²/g) and the accumulate volume increased from 0.07 to 0.66 cc/g. While the micropore surface area dropped from 625 to 497 m²/g.
Comparison Between HY5.1 @ AMO-LDH and HY5.1 @ LDH
A similar procedure was used to synthesise and characterise zeolite @ LDH core-shell using conventionally synthesised LDH, HY5.1 @ LDH, FIG. 4. The morphology of HY5.1 @ LDH-W and HY5.1 @ LDH-A are similar.
FIG. 5 and FIG. 6 are the XRD and TGA results from conventional and AMO-synthesised HY5.1 @ LDH. Both samples show similar crystallinity and weight loss.
Variation of Si/Al ratio in HY @ AMO-LDH
FIG. 7 shows the increased affinity for LDH with increased aluminium content, providing a better Al³⁺ source for LDH growth.
Variation of Other Parameters Using HY30 @ LDH
The coating of LDH on the HY30 surface did not increase by changing temperature and Mg/Al ratio. However, a change in pH and Na₂CO₃ soaking time demonstrated a small improvement in affinity of LDH on the surface.

Variation of Zeolite to LDH Ratio in HY15 @ AMO-LDH
FIG. 9 shows that for HY15, 200 mg seems to possess the best coating of the three. 90% of HY15 has been coated with dense LDH layer when using 200 mg.
Variation of Si/Al Ratio in ZSM5 @ LDH
LDH can easily grow on the surface of ZSM5 regardless of the Si/Al ratio.
Variation of Zeolite to LDH Ratio in ZSM5-23 @ LDH
By increasing the amount of ZSM5-23, the free LDH was reduced. However, less ZSM5 was coated with LDH.
Variation of the Drop Rate in ZSM5-40 @ LDH
Change in the drop rate has no significant effect.
Characterisation of ZSM5-23 @ AMO-LDH
FIG. 13 shows around 50% LDH in the sample ZSM5-23 @ AMO-LDH.

TABLE 1
Summary data from N₂ adsorption and desorption

| | BET | External | Micropore | Micropore | Cumulative |
|---|---|---|---|---|---|
| | SSA | SSA | SSA | volume | Volume |
| Samples | (m²/g) | (m²/g) | (m²/g) | (cc/g) | (cc/g) |
| HY5.1 | 813 | 72 | 740 | 0.28 | 0.08 |
| HY5.1@LDH-W | 565 | 164 | 401 | 0.17 | 0.60 |
| HY5.1@LDH-W | 698 | | 497 | | |
| LDH-W | 11 | 0.4 | 11 | 0.004 | 0.04 |
| LDH-A | 281 | 252 | 29 | 0.01 | 1.08 |
| ZSM5-23 | 424 | 45 | 379 | 0.15 | 0.05 |
| ZSM5-23@LDH- | 167 | 54 | 113 | 0.04 | 0.33 |
| W | | | | | |
| ZSM5-23@LDH-A | 339 | 140 | 199 | 0.08 | 0.05 |
| HY5.1 300° C. | 695 | 70 | 625 | 0.30 | 0.07 |
| HY5.1@LDH-A | 698 | 201 | 497 | 0.23 | 0.66 |
| 300° C. | | | | | |

LDH-W means the LDH was prepared by the conventional method in water.
LDH-A means the LDH was treated with acetone.

FIG. 15 represents the different BET values at various calcination temperatures using HY5.1 @ LDH demonstrating no particular change.
FURTHER CORE @ LAYERED DOUBLE HYDROXIDE SHELL MATERIALS
Variation of the Anion of the LDH
Example Method of HY5.1 @ Mg₂Al—NO₃ LDH-A
HY5.1 (100 mg) was dispersed in deionised water (20 mL) using ultrasound treatment. After 36 minutes, an aqueous solution (19.2 mL) containing magnesium nitrate hexahydrate and aluminium nitrate nonahydrate was added at a rate of 60 mL/h to HY5.1 solution under vigour stirring. The pH of the reaction solution was controlled to 10 with the addition of 1 M NaOH by an autotitrator. The obtained suspension was stirred for 1 h. The obtained solid was collected and then re-dispersed in deionised water (40 mL) and stirred for 1 h. The collection and re-dispersion was repeated once. The solid was treated with AMOST method, which was washed with acetone (40 mL) and then re-dispersed in a fresh acetone (40 mL) under stirring for overnight. The solid was then dried under vacuum oven for materials characterization.
Characterisation
HY5.1 @ Mg₂Al—NO₃ LDH
The same synthesis method is applied to LDH-NO₃. The TEM (FIG. 16) show that the Mg₂Al—NO₃ LDH-A can grow on the surface of HY5.1. However, the amount of LDH on the surface is less, compared to LDH—CO₃ when using the same conditions. The XRD (FIG. 17) indicates that HY5.1 @ Mg₂Al—NO₃ LDH-A has both characterization peaks of HY5.1 and LDH. TGA (FIG. 18) shows that HY5.1 @ Mg₂Al—NO₃ LDH-A exhibits the typical three decompose stage of LDH.
Variation of the Metal of the LDH
Example Method of HY5.1 @ Mg₂Al_{0.8}Fe_{0.2}—CO₃ LDH-A
HY5.1 (100 mg) was dispersed in deionised water (20 mL) using ultrasound treatment. After 36 minutes, an aqueous solution (19.2 mL) containing magnesium nitrate hexahydrate, iron nitrate nonahydrate and aluminium nitrate nonahydrate (Mg:Al:Fe 2:0.8:0.2) was added at a rate of 60 mL/h to HY5.1 solution under vigour stirring. The pH of the reaction solution was controlled to 10 with the addition of 1 M NaOH by an autotitrator. The obtained suspension was stirred for 1 h. The obtained solid was collected and then re-dispersed in deionised water (40 mL) and stirred for 1 h. The collection and re-dispersion was repeated once. The solid was treated with AMOST method, which was washed with acetone (40 mL) and then re-dispersed in a fresh acetone (40 mL) under stirring for overnight. The solid was then dried under vacuum oven for materials characterization.
Characterisation
HY5.1 @ Mg₂Al_{0.8}Fe_{0.2}—CO₃ LDH
The TEM (FIG. 19) show that the Mg₂Al_{0.8}Fe_{0.2}—CO₃ LDH can grow on the surface of HY5.1. The XRD (FIG. 20) indicates that HY5.1 @ Mg₂Al_{0.8}Fe_{0.2}—CO₃ LDH-A has both characterization peaks of HY5.1 and LDH. TGA (FIG. 21) shows that HY5.1 @ Mg₂Al_{0.8}Fe0.2—CO₃ LDH-A exhibits the typical three decompose stage of LDH.
Example Method of HY5.1 @ Mg_{1.8}AlNi_{0.2}—CO₃ LDH-A
HY5.1 (100 mg) was dispersed in deionised water (20 mL) using ultrasound treatment. After 36 minutes, an aqueous solution (19.2 mL) containing magnesium nitrate hexahydrate, nickel nitrate hexahydrate and aluminium nitrate nonahydrate (Mg:Al:Ni 1.8:1:0.2) was added at a rate of 60 mL/h to HY5.1 solution under vigour stirring. The pH of the reaction solution was controlled to 10 with the addition of 1 M NaOH by an autotitrator. The obtained suspension was stirred for 1 h. The obtained solid was collected and then re-dispersed in deionised water (40 mL) and stirred for 1 h. The collection and re-dispersion was repeated once. The solid was treated with AMOST method, which was washed with acetone (40 mL) and then re-dispersed in a fresh acetone (40 mL) under stirring for overnight. The solid was then dried under vacuum oven for materials characterization.
Characterisation
HY5.1 @ Mg_{1.8}AlNi_{0.2}—CO₃ LDH
The TEM (FIG. 22) show that the Mg_{1.8}AlNi_{0.2}—CO₃ LDH-A can grow on the surface of HY5.1. The XRD (FIG. 23) indicates that HY5.1 @ Mg_{1.8}AlNi_{0.2}—CO₃ LDH-A has both characterization peaks of HY5.1 and LDH. TGA (FIG. 24) shows that HY5.1 @ Mg_{1.8}AlNi_{0.2}—CO₃ LDH-A exhibits the typical three decompose stage of LDH.
Mesoporous Silica Based Materials
Example Method of MSN @ Mg₃Al—CO₃ LDH
Generally, MCM-41 (50 mg) was dispersed in deionised water (20 mL) using ultrasound treatment. After 30 minutes, the sodium carbonate was added to the solution and a further 6 minutes of sonication was carried out to form solution A. An aqueous solution (19.2 mL) containing magnesium nitrate hexahydrate and aluminium nitrate nonahydrate was added at a rate of 60 mL/h to solution A under vigorous stirring. The pH of the reaction solution was controlled with the addition of 1 M NaOH by an autotitrator. The obtained suspension was stirred for 1 h. The obtained solid was collected and then re-dispersed in deionised water (40 mL) and stirred for 1 h. The collection and re-dispersion was repeated once. Before final isolation, the solid was treated with AMOST method, which was washed with acetone (40 mL) and then re-dispersed in acetone (40 mL) under stirring for overnight. The samples (MCM-41 @ AMO-LDH) were then dried under vacuum. The other MSN @ AMO-LDH (such as SBA-15 @ AMO-LDH) was synthesized using the same procedure.
Characterisation
MSN @ Mg₃Al—CO₃ LDH
According to X-ray diffraction (XRD) pattern (FIG. 25) of MSN @ LDH, the core of MCM-41 has a mean pore diameter about 3 nm and SBA-15 has a mean pore diameter about 9 nm. The XRD pattern of low angle (FIG. S25 inset) showed that the samples had an high ordered hexagonal structure and high crystallinity, these Bragg peaks can be indexed as (100), and overlapped (110) of the two-dimensional hexagonal mesostructure (space group p6m). Since MCM-41 and SBA-15 consists of amorphous silica, it has no crystallinity at the atomic level. Therefore, only the typical peaks of LDH have been observed at higher degrees. We can observe from the TEM images (FIG. 26) that LDH-nanosheet can grow on the Mesoporous Silica Nanoparticles surface.
Microporous Molecular Sieves @ LDH
Example Method of ALPO-5/SAPO-5 @ LDH
Generally, ALPO-5(100 mg) was dispersed in deionised water (20 mL) using ultrasound treatment. After 30 minutes, the sodium carbonate was added to the solution and a further 6 minutes of sonication was carried out to form solution A. An aqueous solution (19.2 mL) containing magnesium nitrate hexahydrate and aluminium nitrate nonahydrate was added at a rate of 60 mL/h to solution A under vigorous stirring. The pH of the reaction solution was controlled with the addition of 1 M NaOH by an autotitrator. The obtained suspension was stirred for 1 h. The collection and re-dispersion was repeated once. Before final isolation, the solid was treated with AMOST method, which was washed with acetone (40 mL) and then re-dispersed in acetone (40 mL) under stirring for overnight. The samples (ALPO-5 @ AMO-LDH) were then dried under vacuum. The SAPO-5 @ AMO-LDH was synthesized using the same procedure.
SAPO5 @ Mg₃Al—CO₃ LDH & ALPO5 @ Mg₃Al—CO₃ LDH
XRD (FIG. 27) shows typical peaks of ALPO-5/SAPO-5 which is an AFI-type. On the other hand, typical peaks of LDH have been also observed at higher degrees. TEM images (FIGS. 28 and 29) show that LDH can grow on the surface of ALPO and SAPO. However, the thickness is depended on the composites of materials and synthesis method. For example, ALPO with higher Al content could have thicker layer of LDH, comparing SAPO.

While specific embodiments of the invention have been described herein for the purpose of reference and illustration, various modifications will be apparent to a person skilled in the art without departing from the scope of the invention as defined by the appended claims.

1. A core @ layered double hydroxide shell material having the formula
Tₚ@{[M^{z+}₍₁₋ₓ₎M′ₓ^{y+}(OH)₂]^{a+}(Xⁿ⁻)_{a/n}·bH₂O·c(AMO-solvent)}_{q}
wherein T is a solid, porous, inorganic oxide-containing framework material, Mz⁺ is a metal cation of charge z or a mixture of two or more metal cations each independently having the charge z; M′^{y+} is a metal cation of charge y or a mixture of two or more metal cations each independently having the charge y;
z=1 or 2;
y=3 or 4;
0<x<0.9;
b is 0 to 10;
c is 0.01 to 10;
p>0;
q>0;
Xⁿ⁻ is an anion; with n>0;
a=z(1−x)+xy−2; and
AMO-solvent is an organic solvent which is completely miscible with water.

2. A material according to claim 1, wherein T is a molecular sieve material selected from silicate, aluminium silicate, vanadium silicate, iron silicate, silicon-aluminium phosphate (SAPO) and aluminium phosphate (AIPO), preferably an aluminium silicate having a silicon:aluminium ratio of from 1 to 100, more preferably of 1 to 50, most preferably 1 to 40.

3. A material according to claim 1, wherein the aluminium silicate has a framework structure selected from zeolite types LTA, FAU, BEA, MOR and MFI and preferably the aluminium silicate has a framework structure containing non-framework organic and/or inorganic cations, more preferably the non-framework organic and inorganic cations are selected from NR4^{t}, where R is an optionally-substituted alkyl group, Na⁺, K⁺ and Cs⁺.

4. A material according to claim 1, wherein the aluminium silicate is a crystalline aluminosilicate zeolite having a composition in terms of mole ratios of oxides as follows:
αMⁿ⁺_{2/n}O:Al₂O₃:βSiO₂:γH₂0
wherein Mⁿ⁺ is at least one cation having a valence n, α=0.9±0.2; β is at least 2 and γ is between 0 and 40.

5. A material according to claim 1, wherein M′ is Al or Fe and/or M is Li, Mg, Ca, Co, Cu, Ni, or Cr or a mixture of two or more thereof and/or Xⁿ⁻ is selected from CO₃²⁻, OH⁻, F⁻, Cl⁻, Br⁻, SO₄²⁻, NO₃⁻ and PO₄³⁻, preferably from CO₃²⁻, Cl⁻ and NO₃⁻, or a mixture of two or more thereof.

6. A material according to claim 1, wherein M is Mg, M′ is Al and Xⁿ⁻ is CO₃⁻.

7. A material according to claim 1, wherein the core @ layered double hydroxide shell material has the general formula Id
Tₚ@{[M^{z+}₍₁₋ₓ₎M′^{y+}ₓ(OH)₂]^{a+}(Xⁿ⁻)_{a/n}·bH₂O·c(ethanol)}_{q} (Id)
wherein,
T is; i) an aluminium silicate with a framework structure selected from zeolite types LTA, FAU, BEA, MOR or MFI; ii) an aluminophosphate; iii) a silicoaluminophosphate; or iv) a mesoporous silicate, wherein the aluminium silicate has a silicon:aluminium ratio of from 1 to 50, more preferably of 1 to 40, most preferably of 1 to 30; and the aluminium silicate has a framework structure containing non-framework organic and/or inorganic cations, more preferably the non-framework organic and inorganic cations are selected from NR₄⁺, where R is an optionally-substituted alkyl group, Na⁻, K⁺ and Cs⁺;
M^{z+} is selected from Li⁺, Ca²⁺, Cu²⁺, Zn²⁺, Ni²⁺ or Mg²⁺, and M′^{y+} is Al³⁺, Ga³⁺, In³⁺, Fe³⁺;
0<x<0.9;
b is 0 to 10;
c is 0.01 to 10;
p>0,
q>0;
Xⁿ⁻ is is selected from CO₃²⁻ or NO₃⁻; with n>0 (preferably 1-5)
a=z(1−x)+xy−2.

8. A method of making a core @ layered double hydroxide shell material according to claim 1, having the formula
Tₚ@{[M^{z+}₍₁₋ₓ₎M′ₓ^{y+}(OH)₂]^{a+}(Xⁿ⁻)_{a/n·bH}₂O·c(AMO-solvent)}_{q}
wherein T is a solid, porous, inorganic oxide-containing framework material, M^{z+} is a metal cation of charge z or a mixture of two or more metal cations each independently having the charge z; M′^{y+} is a metal cation of charge y or a mixture of two or more metal cations each independently having the charge y;
z=1 or 2;
y=3 or 4;
0<x<0.9;
b is 0 to 10;
c is 0.01 to 10;
p>0;
q>0;
Xⁿ⁻ is an anion; with n>0;
a=z(1−x)+xy−2; and
AMO-solvent is an organic solvent which is completely miscible with water;
which method comprises the steps:
(a) contacting a metal ion-containing solution containing metal ions M^{z+} and M′^{y+} and particles of the framework material in the presence of a base and an anion solution; and
(b) optionally treating the product with AMO-solvent and recovering the solvent treated material to obtain the core @ layered double hydroxide material.

9. A method according to claim 8, wherein T is a molecular sieve material selected from silicate, aluminium silicate, vanadium silicate, iron silicate, silicon-aluminium phosphate (SAPO) and aluminium phosphate (AIPO).

10. A method according to claim 8, wherein T is a molecular sieve material which is an aluminium silicate having a silicon:aluminium ratio of from 1 to 100, preferably 1 to 50, more preferably 1 to 40.

11. A method according to claim 8, wherein the aluminium silicate is a crystalline aluminosilicate zeolite having a composition in terms of mole ratios of oxides as follows:
αMⁿ⁺_{2/n}O:Al₂O₃:SiO₂:γH₂0
wherein Mⁿ⁺ is at least one cation having a valence n, α=0.9±0.2; β is at least 2 and γ is between 0 and 40.

12. A core @ mixed metal oxide material having the formula
Tₚ@{[M^{z+}₁₋ₓM′^{y+}ₓO_{w}]ₚŸ]
wherein T is a solid, porous, inorganic oxide-containing framework material, M^{z+}₁₋ₓM′^{y+}ₓO_{w} is a mixed metal oxide, or mixture of mixed metal oxides, which may be crystalline or non-crystalline, wherein M^{z+} and M′^{y+} are different charged metal cations; M^{z+} is a metal cation of charge z or a mixture of two or more metal cations each independently having the charge z; M′^{y+} is a metal cation of charge y or a mixture of two or more metal cations each independently having the charge y; z is 1 or 2; y is 3 or 4; 0<x<0.9; w>0; p>0 and q>0; Ÿ is the residue of an Xⁿ⁻ anion in which n>0.

13. A method of making a core @ mixed metal oxide according to claim 12, which method comprises subjecting a core @ layered double hydroxide shell material having the formula
Tₚ@{[M^{z+}₍₁₋ₓ₎M′ₓ^{y+}(OH)₂]^{a+}(Xⁿ⁻)_{a/n}·bH₂O·c(AMO-solvent)}_{q}
wherein T is a solid, porous, inorganic oxide-containing framework material, to heat treatment wherein
M^{z+} is a metal cation of charge z or a mixture of two or more metal cations each independently having the charge z; M′^{y+} is a metal cation of charge y or a mixture of two or more metal cations each independently having the charge y;
z=1 or 2;
y=3 or 4;
0<x<0.9;
b is 0 to 10;
c is 0.01 to 10;
p>0;
q>0;
Xⁿ⁻ is an anion; with n>0;
a=z(1−x)+xy−2; and
AMO-solvent is an organic solvent which is completely miscible with water.

14. A method according to claim 13, wherein the core @ layered double hydroxide shell material is subjected to heat treatment at a temperature of from 100 to 1000° C., preferably from 400 to 550° C.

15. A method according to claim 13, wherein the heat treatment is carried out in specific atmosphere, preferably in air or a nitrogen atmosphere or hydrogen atmosphere.
